(19) United States
(12) Patent Application Publication
(10) Pub. No.: US 2023/0236889 A1
(43) Pub. Date: Jul. 27, 2023

(54) DISTRIBUTED ACCELERATOR

(71) Applicant: Microsoft Technology Licensing, LLC, Redmond, WA (US)

(72) Inventors: Gagan GUPTA, Bellevue, WA (US); Andrew Joseph RUSHING, Apex, NC (US); Eric Francis ROBINSON, Raleigh, NC (US)

(21) Appl. No.: 17/585,842

(22) Filed: Jan. 27, 2022

(51) Int. Cl. G06F 9/50; G06F 9/30

(52) U.S. Cl. CPC G06F 9/5027; G06F 9/30007; G06F 15/7867

(57) ABSTRACT

Systems, methods, and devices are described coordinating a distributed accelerator. A command that includes instructions for performing a task is received. One or more sub-tasks of the task are determined to generate a set of sub-tasks. For each sub-task of the set of sub-tasks, an accelerator slice of a plurality of accelerator slices of a distributed accelerator is allocated, sub-task instructions for performing the sub-task are determined. Sub-task instructions are transmitted to the allocated accelerator slice for each sub-task. Each allocated accelerator slice is configured to generate a corresponding response indicative of the allocated accelerator slice having completed a respective sub-task. In a further example aspect, corresponding responses are received from each allocated accelerator slice and a coordinated response indicative of the corresponding responses is generated.

### BACKGROUND

Computer architects implement accelerators to improve performance by introducing hardware specialized for performing specific application tasks. A program submits a task to be accelerated to the accelerator. The accelerator computes and returns the result for the program to consume. Communication between the program, the accelerator, and associated systems may incur overhead, depending on the particular implementation. For instance, task off-loading, completion notification, computation latency, and queue delays may reduce realized performance increases. In some cases, the performance of an accelerator is reduced by the communication overhead. For instance, if a task has a small computation granularity, the benefits of using an accelerator may be negated due to the time used for off-loading the task and/or by queue delays. Multiple small computation granularity tasks may generate a large amount of traffic in a processor core, potentially polluting caches and generating coherence traffic.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses are described for a distributed accelerator. The distributed accelerator includes a plurality of accelerator slices, including a coordinator slice and one or more subordinate slices. A command that includes instructions for performing a task is received. Sub-tasks of the task are determined to generate a set of sub-tasks. For each sub-task of the set of sub-tasks, an accelerator slice of the plurality of accelerator slices is allocated, and sub-task instructions for performing the sub-task are determined. Sub-task instructions are transmitted to the allocated accelerator slice for each sub-task. Each allocated accelerator slice is configured to generate a corresponding response indicative of the allocated accelerator slice having completed a respective sub-task.

In a further aspect, responses are received from each allocated accelerator slice and a coordinated response indicative of the responses is generated.

Further features and advantages of the embodiments, as well as the structure and operation of various embodiments, are described in detail below with reference to the accompanying drawings. It is noted that the claimed subject matter is not limited to the specific examples described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a processing system including a distributed accelerator, according to an example embodiment.

FIG. 2 is a block diagram of a processing system that includes an example implementation of the distributed accelerator of FIG. 1, according to an embodiment.

FIG. 3A is a block diagram of a processing system that includes a distributed accelerator configured to perform a task for a processor core, according to an example embodiment.

FIG. 3B is a block diagram of a subordinate slice corresponding to a subordinate slice shown in the example processing system of FIG. 3A.

FIG. 4 is a flowchart of a process for coordinating sub-tasks among a plurality of accelerator slices, according to an example embodiment.

FIG. 5 is a block diagram of a processing system that includes a processor core and a distributed accelerator configured to generate a coordinated status update, according to an example embodiment.

FIG. 6 is a flowchart of a process for generating a coordinated status update, according to an example embodiment.

FIG. 7 is a block diagram of a processing system that includes a processor core and a distributed accelerator configured to abort one or more sub-tasks, according to an example embodiment.

FIG. 8 is a flowchart of a process for aborting one or more sub-tasks, according to an example embodiment.

FIG. 9 is a block diagram of a completion time estimator that is an implementation of the completion time estimator shown in the example distributed accelerator of FIG. 3A, according to an embodiment.

FIG. 10 is a flowchart of a process for evaluating an estimated completion time of a command, according to an example embodiment.

FIG. 11 is a block diagram of a processing system including various types of coordinator slices, according to an example embodiment.

FIG. 12 is a block diagram of a processing system for performing a data movement process, according to an example embodiment.

FIG. 13 is a flowchart of a process for moving data, according to an example embodiment.

FIG. 14 is a block diagram of a cyclic redundancy check (CRC) coordinator slice, according to an example embodiment.

FIG. 15 is a block diagram of a processing system for performing a complex computation, according to an example embodiment.

FIG. 16 is a flowchart of a process for performing a complex computation, according to an example embodiment.

FIG. 17 is a block diagram of an example computer system that may be used to implement embodiments.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

The example embodiments described herein are provided for illustrative purposes and are not limiting. The examples described herein may be adapted to any type of method or system for secure account login and authentication. Further structural and operational embodiments, including modifications/alterations, will become apparent to persons skilled in the relevant art(s) from the teachings herein.

Numerous exemplary embodiments are now described. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Distributed Accelerator Embodiments

A hardware accelerator (“accelerator”) is a separate unit of hardware from a processor (e.g., a central processing unit (CPU)) that is configured to perform functions for a computer program executed by the processor upon request by the program, and optionally in parallel with operations of the program executing in the processor. Computer architects implement accelerators to improve performance by introducing such hardware specialized for performing specific application tasks. A program executed by a processor submits a task to be accelerated to the accelerator. The accelerator computes and returns the result for the program to consume. The accelerator includes function-specific hardware, allowing for faster computation speeds while being energy efficient.

Programs may interface with the accelerator synchronously or asynchronously. In synchronous operation, the program waits for the accelerator to return a result before advancing. In asynchronous operation, the program may perform other tasks after submitting the function to the accelerator. In this scenario, to notify completion, the accelerator may interrupt the program, or the program may poll the accelerator. In some embodiments, both asynchronous and synchronous operations may be used.

Communication between the program, the accelerator, and associated systems may incur overhead, depending on the particular implementation. For instance, task off-loading, completion notification, computation latency, and queue delays may reduce or offset realized performance increases. In some cases, the increased performance of the accelerator is negated by the communication overhead. For instance, if a task has a small computation granularity, the benefits of using an accelerator may be negated due to the time used to off-load the task and/or by queue delays. However, multiple small computation granularity tasks may generate a large amount of traffic in a processor core, potentially polluting caches and generating coherence traffic.

Embodiments of the present disclosure present a distributed accelerator. A distributed accelerator may achieve higher degrees of parallelism and increased bandwidth for data access. A distributed accelerator includes a plurality of separate accelerator slices in a computing system that each can perform hardware acceleration on a portion of a task of a computer program. In accordance with an embodiment, each accelerator slice has an independent interface. Different accelerator slices may implement similar or different functions.

Accelerator slices may be distributed in a computing system in various ways. For instance, an accelerator may be integrated as a network-attached device, an off-chip input/output (TO) device, or an on-chip IO device, an on-chip processing element, as a specialized instruction in the instruction set architecture (ISA), and/or the like, depending on the particular implementation. In some embodiments, accelerator slices of a distributed accelerator may be integrated in different ways. For instance, in accordance with an embodiment, a distributed accelerator includes accelerator slices integrated in corresponding on-chip IO devices and on-chip processing elements. The particular configuration may be determined based on computation-to-communication ratio, number of shared users, cost, frequency of use within a program, complexity, characteristics of the computation, and/or other factors as would be understood by a person of skill in the relevant art(s) having the benefit of this disclosure. For instance, an accelerator slice implemented as an extension of an ISA may utilize CPU resources such as available memory bandwidth. In another example, an accelerator slice implemented as an off-chip device may be shared between more users. In accordance with an embodiment, a distributed accelerator may dynamically select accelerator slices based on the assigned task and accelerator integration type.

Distributed accelerators may be configured to operate in memory regions of various sizes. For instance, a distributed accelerator in accordance with an implementation may operate in a large memory region. In this context, the memory region is divided into multiple page-sized chunks aligned to page boundaries. The distributed accelerator or a processor core may determine page sizes and/or boundaries, depending on the particular implementation.

Embodiments of distributed accelerators are configured to accelerate functions of a computer processing system. For instance, a distributed accelerator may be configured to process data instructions (e.g., data movement instructions, encryption instructions, synchronization instructions, CRC instructions, etc.) and accelerate functions of a computer processing system. For example, a data movement function in an example implementation may be accelerated with twice as much bandwidth (or even greater bandwidths, depending on the particular implementation) as the processor core of the computer processing system via a distributed accelerator. A distributed accelerator distributes the data moving function across the computer processing system. For instance, accelerator slices coupled to the computer processing system interconnect, within components of the computer processing system (e.g., a cache controller), and/or coupled to IO devices of the computer processing system may be used to distribute traffic across system resources, improving data movement speed.

Distributed accelerators may be utilized in various applications. For instance, a distributed accelerator in accordance with an embodiment is shared across multiple users in a system that includes active virtual machines. Each virtual machine includes multiple active containers. In this context, tens, hundreds, thousands, or even greater numbers of users may invoke the distributed accelerator. The distributed accelerator is configured to enable sharing between users.

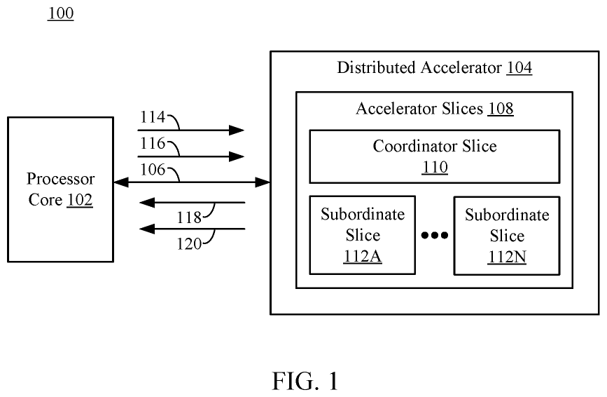

Distributed accelerators may be configured in various ways. For instance, FIG. 1 is a block diagram of a processing system 100 including a distributed accelerator, according to an example embodiment. As shown in FIG. 1, processing system includes a processor core 102 and a distributed accelerator 104. Processor core 102 and distributed accelerator 104 may be communicatively coupled or linked to each other by a communication link 106. Communication link 106 may comprise one or more physical (e.g., wires, cables, conductive traces, system buses, etc.) and/or wireless (e.g., radio frequency, infrared, etc.) communication connections, or any combination thereof. For example, in a computer system embodiment, communication link 106 may be a physical interconnect communicatively coupling processor core 102 and distributed accelerator 104.

Processor core 102 is configured to execute programs, transmit commands to distributed accelerator 104, receive responses from distributed accelerator 104, and perform other tasks associated with processing system 100. For example, processor core 102 transmits a command 114 to distributed accelerator 104 via communication link 106. Command 114 includes instructions for performing a task. Distributed accelerator 104 performs the task according to the instructions and generates a response 118 that is transmitted to processor core 102. Processor core 102 receives response 118 from distributed accelerator 104 via communication link 106.

Command 114 may be a message including one or more processes to be completed, source addresses, destination address, and/or other information associated with the task. In accordance with an embodiment, processor core 102 stores the command in memory of processing system 100 (e.g., a memory device, a register, and/or the like) and notifies distributed accelerator 104 of the location of the command. In accordance with an embodiment, processor core 102 generates command 114 in response to executing an instruction. Command 114 may be a complex command including multiple sub-tasks. Command 114 may be identified with a program using a command identifier (CID). The CID may include a number associated with processor core 102, a program identifier (e.g., an address space identifier (ASID)), and/or other identifying information associated with command 114.

Distributed accelerator 104 is configured to receive commands from processor core 102, perform tasks, and generate responses. Distributed accelerator 104 may be discovered and configured via an operating system (OS) and operated in a user-mode, depending on the particular implementation. Distributed accelerator 104 includes a plurality of accelerator slices 108. Each accelerator slice of accelerator slices 108 includes an independent interface for accessing data. Accelerator slices 108 may implement similar or different functions, depending on the particular implementation. As shown in FIG. 1, accelerator slices 108 include a coordinator slice 110 and a plurality of subordinate slices 112A-112N.

Coordinator slice 110 is configured to receive commands from processor core 102, divide tasks into sub-tasks, and distribute sub-tasks to accelerator slices of accelerator slices 108. For instance, coordinator slice 110 receives command 114 from processor core 102, and is configured to decode command 114 into instructions for performing a task, and determine if the task is to be completed by coordinator slice 110, one or more of subordinate slices 112A-112N, or a combination of coordinator slice 110 and one or more of subordinate slices 112A-112N. For example, in accordance with an embodiment, coordinator slice 110 divides the task associated with command 114 into a set of sub-tasks and allocates an accelerator slice of accelerator slices 108 to each sub-task. Sub-tasks may be distributed across accelerator slices 108 based on the type of the sub-task, the address range the sub-task operates on, or other criteria, as would be understood by a person of skill in the relevant art(s) having benefit of this disclosure. In accordance with an embodiment, each allocated accelerator slice may transmit results regarding execution of its respective sub-task directly to processor core 102 (e.g., as response 118). In accordance with another embodiment, coordinator slice 110 receives responses from each allocated accelerator slice and generates a coordinated response. In this context, coordinator slice 110 transmits the generated coordinated response to processor 102 as response 118.

Accelerator slices 108 may be configured to communicate to each other in various ways. For instance, accelerator slices 108 may communicate through distributed accelerator registers, system memory, system interconnects, and/or other communication methods described herein or otherwise understood by a person of ordinary skill in the relevant art(s) having benefit of this disclosure. Accelerator slices 108 may be cache coherent, which reduces coherence traffic.

Distributed accelerator 104, as depicted in FIG. 1, includes a single coordinator slice, however it is contemplated herein that distributed accelerators may include multiple coordinator slices. Furthermore, it is contemplated herein that a coordinator slice, such as coordinator slice 110, may operate as a subordinate slice to another coordinator slice, depending on the particular implementation. For instance, an accelerator slice in accordance with an embodiment is designated as a coordinator slice for a data movement function; however, the accelerator slice may be designated as a subordinate slice for an encryption and data movement function. Moreover, an accelerator slice may be designated as the coordinator slice depending on other factors, such as the memory address associated with the received command, availability of accelerator slices, bandwidth availability, and/or the like.

Processor core 102 may operate synchronously or asynchronously to distributed accelerator 104. In synchronous operation, processor core 102 waits for distributed accelerator 104 to provide response 118, indicating the task is completed. In asynchronous operation, processor core 102 may perform other tasks after transmitting command 114, while distributed accelerator 104 executes command 114.

In asynchronous operation, processor core 102 may receive response 118 in a variety of ways, depending on the particular implementation. In a first example embodiment, processor core 102 transmits a poll signal 116 to distributed accelerator 104 to check if distributed accelerator 104 has completed the task. If distributed accelerator 104 has completed the task, distributed accelerator 104 transmits response 118 to processor core 102 in response to poll signal 116. In this context, processor core 102 may transmit poll signal 116 periodically, as part of another operation of processing system 100, or at the direction of a user associated with processing system 100. In a second example embodiment, distributed accelerator 104 transmits an interrupt signal 120 to processor core 102 to interrupt the current operation of processor core 102. After processor core 102 acknowledges the interrupt, distributed accelerator 104 transmits response 118.

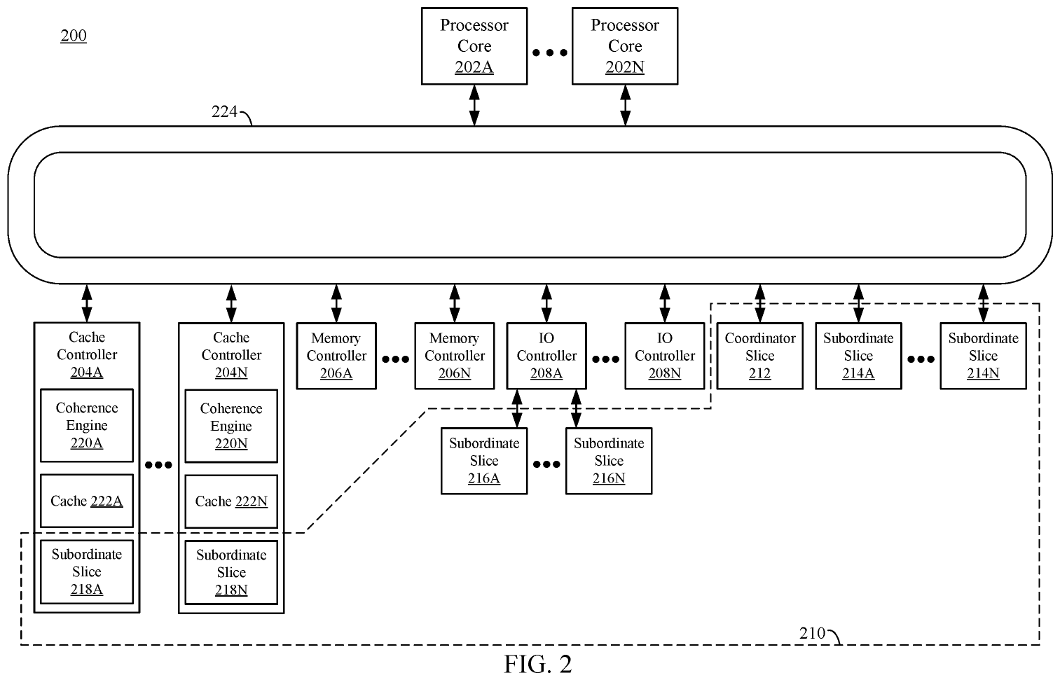

Processing systems including distributed accelerators may be configured in various ways. For instance, FIG. 2 is a block diagram of a processing system 200 including a distributed accelerator 210, according to an example embodiment. Processing system 200 is a further embodiment of processing system 100 of FIG. 1. Processing system 200 includes processor cores 202A-202N, cache controllers 204A-204N, memory controllers 206A-206N, IO controllers 208A-208N, and distributed accelerator 210. Processor cores 202A-202N, cache controllers 204A-204N, memory controllers 206A-206N, IO controllers 208A-208N, and distributed accelerator 210 may be communicatively coupled (e.g., linked) to each other by interconnect 224. Interconnect 224 is a computer system bus or other form of interconnect configured to communicatively couple components of processing system 200. Interconnect 224 may be a further embodiment of communication link 106 of FIG. 1.

Processor cores 202A-202N are further embodiments of processor core 102 of FIG. 1, and, for the purposes of illustration for FIG. 2, each may be configured the same, or substantially the same, as processor core 102 above. That is, processor cores 202A-202N are each configured to send commands to and receive responses from distributed accelerator 210 via interconnect 224.

Cache controllers 204A-204N are configured to store and access copies of frequently accessed data. Cache controllers 204A-204N include respective coherence engines 220A-220N and respective caches 222A-222N. Caches 222A-222N store data managed by respective cache controllers 204A-204N. Coherence engines 220A-220N are configured to maintain data consistency of respective caches 222A-222N.

Memory controllers 206A-206N are configured to manage data stored in memory devices of processing system 200 (not shown in FIG. 1 for brevity and illustrative clarity). Memory controllers 206A-206N may be integrated memory controllers, on-chip memory controllers, or external memory controllers integrated on another chip coupled to processing system 200 (e.g., a memory controller integrated in an external memory device).

IO controllers 208A-208N are configured to manage communication between processor cores 202A-202N and peripheral devices (e.g., USB (universal serial bus) devices, SATA (Serial ATA) devices, ethernet devices, audio devices, HDMI (high-definition media interface) devices, disk drives, etc.).

Distributed accelerator 210 is a further embodiment of distributed accelerator 104 of FIG. 1, and, for the purposes of illustration for FIG. 2, is configured the same, or substantially the same, as distributed accelerator 104 above. That is, distributed accelerator 210 is configured to receive commands, perform tasks, and generate responses. For instance, distributed accelerator may receive commands from one or more of processor cores 202A-202N via interconnect 224. As depicted in FIG. 2, distributed accelerator 210 includes a coordinator slice 212, subordinate slices 214A-214N, subordinate slices 216A-216N, and subordinate slices 218A-218N.

Coordinator slice 212 is a further embodiment of coordinator slice 110 of FIG. 1. Coordinator slice 212 is configured to receive commands from processor cores 202A-202N and distribute sub-tasks among itself, subordinate slices 214A-214N, subordinate slices 216A-216N, and subordinate slices 218A-218N. As depicted in FIG. 2, coordinator slice 212 is coupled to interconnect 224, however it is contemplated herein that coordinator slice 212 may be coupled to one of IO controllers 208A-208N (e.g., as an off-chip accelerator slice) or integrated within a component of processing system 200 (e.g., one of cache controllers 204A-204N, memory controllers 206A-206N, or another component of processing system 200).

Subordinate slices 214A-214N, subordinate slices 216A-216N, and subordinate slices 218A-218N are further embodiments of subordinate slices 112A-112N of FIG. 1. Subordinate slices 214A-214N are subordinate accelerator slices configured as components of processing system 200. Communication overhead between subordinate slices 214A-214N, coordinator slice 212, and processor cores 202A-202N utilizes direct access to the bandwidth of interconnect 224. In this context, “direct access” indicates that the subordinate slice is coupled to interconnect 224 without an IO (input-output) controller (e.g., IO controllers 208A-208N). In this case, subordinate slices 214A-214N include interfaces coupled to interconnect 224. Depending on the implementation, the bandwidth of interconnect 224 may be greater than an IO expansion device or processor cores 202A-202N.

Subordinate slices 216A-216N are subordinate accelerator slices configured as off-chip accelerator slices coupled to IO controller 208A. Subordinate slices 216A-216N may be expandable accelerator slices. For instance, off-chip accelerator slices may be coupled to interconnect 224 via an IO controller, such as IO controller 208A in FIG. 2. While FIG. 2 shows subordinate slices 216A-216N coupled to IO controller 208A, subordinate slices may be coupled to any number of IO controllers, depending on the particular implementation.

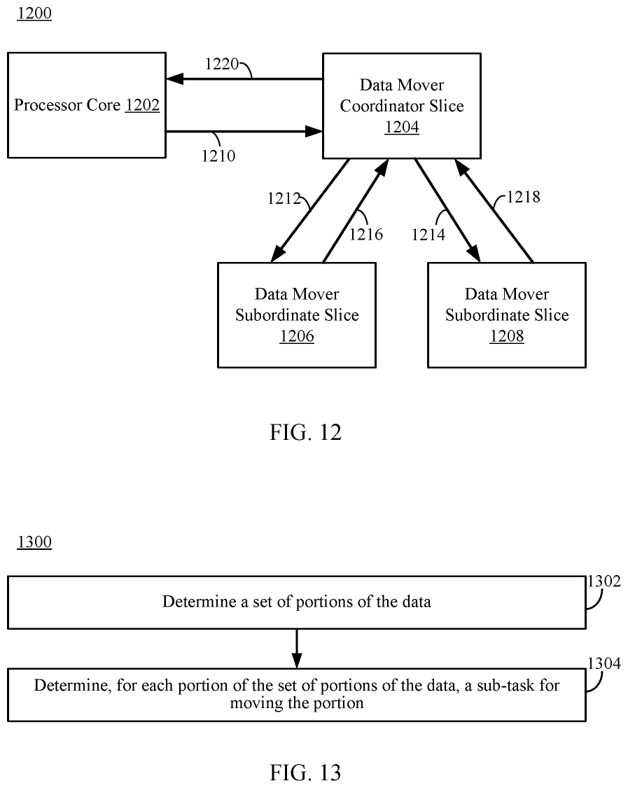

Subordinate slices 218A-218N are subordinate accelerator slices configured as components of respective cache controllers 204A-204N. In this context, each of subordinate slices 218A-218N may utilize respective coherence engines 220A-220N and respective caches 222A-222N. For instance, subordinate slices 218A-218N may use coherence engines 220A-220N for data movement functions, as described further below with respect to FIGS. 12 and 13. While subordinate slices 218A-218N are integrated in cache controllers 204A-204N, as shown in FIG. 2, it is contemplated herein that subordinate slices of distributed accelerator 210 may be integrated in other components of processing system 200, such as memory controllers 206A-206N. For instance, a subordinate slice integrated in memory controller 206A may directly access memory associated with memory controller 206A. Furthermore, coordinator slice 212 may coordinate subordinate slices integrated within different controllers depending on a command received from processor core 202A.

Distributed accelerator 210 utilizes coordinator slice 212, subordinate slices 214A-214N, subordinate slices 216A-216N, and subordinate slices 218A-218N to perform tasks associated with commands received from processor cores 202A-202N. Distributing tasks across multiple accelerator slices utilizes spatial parallelism of multiple attach points to reduce hotspots.

Distributed accelerator 104 is depicted as having a single coordinator slice 212, however it is contemplated herein that multiple coordinator slices may be used. For instance, any of subordinate slices 214A-214N, subordinate slices 216A-216N, and/or subordinate slices 218A-218N may be replaced with or configured as a coordinator slice, depending on the particular implementation. In accordance with an embodiment, a processing system may have a number of accelerator slices equal to the number of cache controllers and memory controllers in the processing system.

Distributed accelerator 210 may provide responses to processor cores 202A-202N in various ways. For instance, each accelerator slice allocated by coordinator slice 212 may transmit a response to the processor core that issued the command. In another example embodiment, coordinator slice 212 receives each response from the allocated accelerator slices and generates a coordinated response as an aggregate of the received responses. In this context, coordinator slice 212 transmits the coordinated response to the processor core that issued the command. In another example embodiment, distributed accelerator 210 may store responses in caches (e.g., one or more of caches 222A-222N) or memory (e.g., a memory associated with one or more of memory controllers 206A-206N). In this context, distributed accelerator 210 or the associated controller may alert the processor core that issued the command (e.g., via an interrupt) or the processor may poll the cache controller or memory controller for a response.

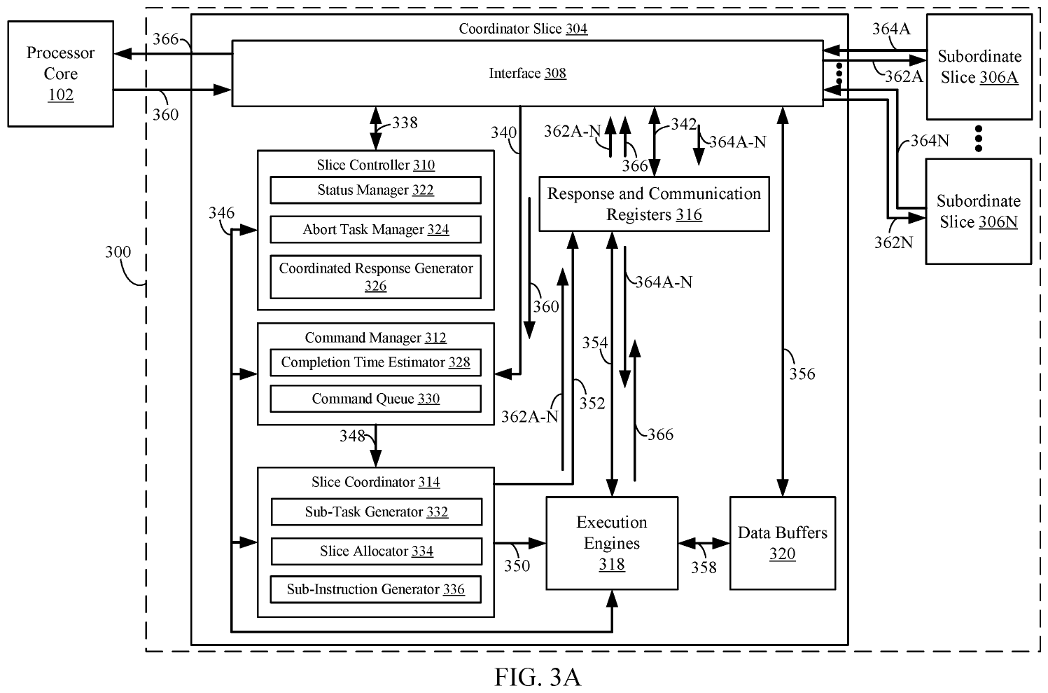

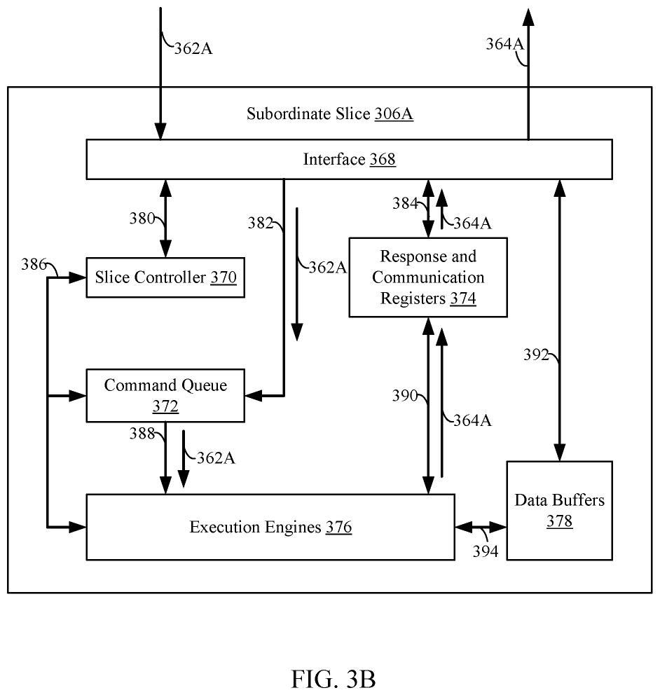

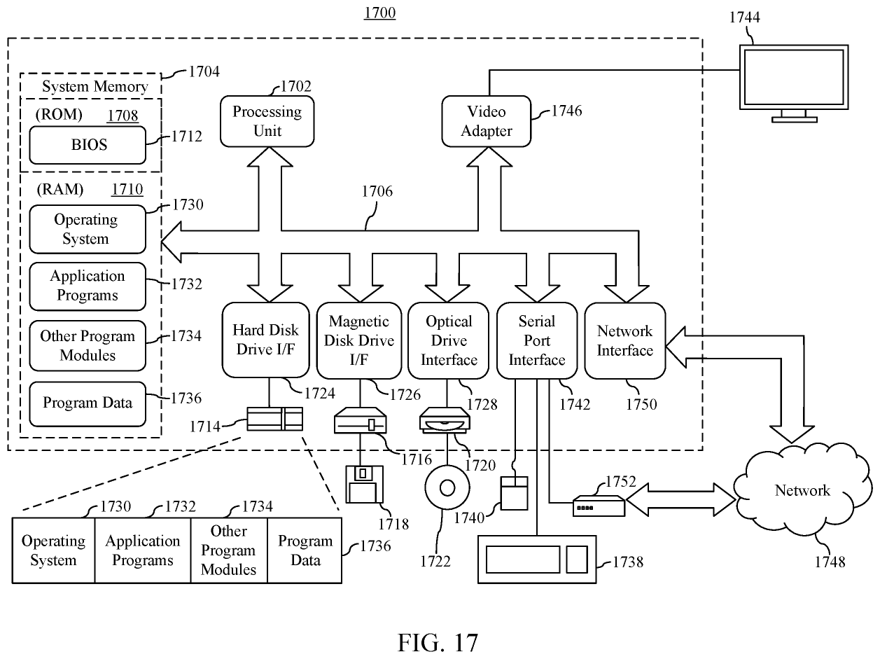

Processing system 200 may include additional components (not shown in FIG. 2 for brevity and illustrative clarity), including, but not limited to, components and subcomponents of other devices and/or systems herein, as well as those described with respect to FIGS. 3A-3B, FIG. 5, FIG. 7, FIG. 9, FIGS. 11-12, FIGS. 14-15, and/or FIG. 17, including software such as an operating system (OS), according to embodiments.

Distributed accelerators may be configured in various ways. For instance, FIG. 3A is a block diagram of a processing system 380 that includes processor core 102 and a distributed accelerator 300, according to an example embodiment. Distributed accelerator 300 is a further embodiment of distributed accelerator 304 of FIG. 1. Distributed accelerator 300 includes a coordinator slice 304 and subordinate slices 306A-306N.

Coordinator slice 304 is a further embodiment of coordinator slice 110 of FIG. 1. Coordinator slice includes an interface 308, a slice controller 310, a command manager 312, a slice coordinator 314, response and communication registers 316, execution engines 318, and data buffers 320. Interface 308 may include any type or number of wired and/or wireless communication or network adapters, modems, etc., configured to enable coordinator slice 304 to communicate intra-system with components thereof, as well as processor 102 and subordinate slices 306A-306N over a communication network, such as interconnect 224 of FIG. 2. For instance, interface 308 receives a command 360 including instructions for performing a task from and provides a response 366 to processor core 102. Interface 308 may include registers for receiving and transmitting control and status signals.

Response and communication registers 316 may be any type of registers that are described herein, and/or as would be understood by a person of skill in the relevant art(s) having the benefit of this disclosure. Response and communication registers 316 may include one or more registers for communicating with processor core 102 and/or subordinate slices 306A-306N. For instance, response and communication registers 316 may be used to communicate messages to and from subordinate slices 306A-306N. Results of coordinator slice 104 completing tasks may be communicated to processor 102 via response and communication registers 316. Response and communication registers 316 are communicatively coupled to interface 308 via response bus 342.

Data buffers 320 may be any type of data buffer that are described herein, and/or as would be understood by a person of skill in the relevant art(s) having the benefit of this disclosure. Data buffers 320 may be used to store data to be processed by or data that has been processed by coordinator slice 304. Data buffers 320 receives data to be processed from interface 308 via data bus 356. Interface 308 receives data processed by coordinator slice 304 from data buffers 308 via data bus 356.

Slice controller 310 is configured to manage coordinator slice 304 and components thereof. For example, slice controller 310 receives control signals from processor core 102 and provides status updates to processor core 102 via control and status bus 338. Slice controller 310 is further configured to configure components of coordinator slice 304 via configuration and status bus 346. Slice controller 310 includes a status manager 322, an abort task manager 324, and a coordinated response generator 326. Status manager 322 is configured to monitor the operation status of coordinator slice 304 and subordinate slices 306A-306N via configuration and status bus 346. Status manager 322 may poll allocated accelerator slices for sub-task or task status (e.g., via slice coordinator 314), may detect errors or exceptions in accelerator slice operation (e.g., via configuration and status bus 346), and/or otherwise monitor the operation status of coordinator slice 304 and subordinate slices 306A-306N, as described elsewhere herein.

Abort task manager 324 is configured to abort tasks or sub-tasks managed by coordinator slice 304. For instance, abort task manager 324 may be configured to abort a task or sub-task in response to an abort command from processor 102, abort a task or sub-task due to an error or exception, and/or otherwise abort a task or sub-task managed by coordinator slice 304, as described elsewhere herein.

Coordinated response generator 326 is configured to generate coordinated responses to send to processor core 102. For instance, coordinator slice 304 receives a corresponding response from each allocated accelerator slice indicative of the allocated accelerator slice having completed a respective sub-task. Coordinated response generator 326 generates a coordinated response 366 indicative of the corresponding responses. In accordance with an embodiment, coordinated response 366 is transmitted to execution engines 318 via configuration and status bus 346, which stores coordinated response 366 in response and communication registers 316 via response bus 354. Coordinator slice 304 transmits coordinated response 366 to processor core 102. Coordinated response 366 may be transmitted to or received by processor core 102 in various ways, as described elsewhere herein.

Command manager 312 is configured to manage commands received by coordinator slice 304. For instance, coordinator slice 304 receives command 360 from processor core 102. Command manager 312 receives command 360 via command bus 340. Command manager 312 is configured to determine if distributed accelerator 300 is capable of performing the task associated with command 360 and manage commands coordinated by coordinator slice 304. Command manager 312 includes a completion time estimator 328 and a command queue 330. Completion time estimator is configured to estimate a completion time of the task associated with command 360. Command manager 312 may determine if distributed accelerator 300 is capable of performing the task based on the estimated completion time. For instance, if the completion time is greater than a threshold, command manager 312 may reject command 360. If the completion time is lower than the threshold, command manager 312 adds command 360 to command queue 330. Command queue 330 is configured to store commands waiting to be processed by coordinator slice 304. Queued commands may include information such as buffer sizes, command latency, and/or other information associated with queued commands. Command manager 312 is configured to generate an instruction to execute commands in command queue 330.

Slice coordinator 314 is configured to coordinate accelerator slices of distributed accelerator 300 to perform commands in command queue 330. For instance, slice coordinator 314 receives an instruction to execute a command from command manager 312 via instruction bus 348 and coordinates accelerator slices to perform the command. Slice coordinator 314 includes a sub-task generator 332, a slice allocator 334, and a sub-instruction generator 336. Sub-task generator 332 is configured to receive the command from command manager 312 and determine one or more sub-tasks of the task to generate a set of sub-tasks. Sub-tasks may be determined in various ways. For instance, a task may be divided based on bandwidth needed to complete a task, size of data to be moved or manipulated, types of steps to be performed, or as described elsewhere herein.

Slice allocator 334 is configured to allocate an accelerator slice of distributed accelerator 300 to perform a sub-task. For instance, slice allocator 334 may allocate coordinator slice 304, one or more of subordinate slices 306A-306N, or a combination of coordinator slice 304 and one or more of subordinate slices 306A-306N. In embodiments, an accelerator slice may be allocated to perform a single sub-task or multiple sub-tasks. Slice allocator 334 may allocate an accelerator slice based on the type of accelerator slice, the type of sub-task, the latency of the sub-task, a load of the accelerator slice, or other factors described elsewhere herein.

Sub-instruction generator 336 is configured to determine, for each sub-task, sub-task instructions for performing the sub-task of the set of sub-tasks. Generated sub-instructions are transmitted to their respective allocated slices. For instance, sub-task instructions allocated to coordinator slice 304 are transmitted via engine instruction bus 350 to execution engines 318 and sub-task instructions 362A-N allocated to subordinate slices 306A-306N are transmitted to response and communication registers 316 via subordinate instruction bus 352.

Execution engines 318 are configured to perform sub-tasks allocated to coordinator slice 304 by slice allocator 334. For instance, execution engines 318 receive allocated sub-tasks via engine instruction bus 350. Execution engines 318 access corresponding responses 364A-N from other allocated slices via response bus 354 and access data stored in data buffers 320 via execution data bus 358. Execution engines 318 generate responses indicative of completing a task. Generated responses may either be transmitted to coordinated response generator 326 via configuration and status bus 346 or to response and communication registers 316 via response bus, depending on the particular implementation. For instance, if coordinator slice 304 is generating an individual response, execution engines 318 may transmit the response to response and communication registers 316 for storage and communication to processor core 102.

Subordinate slices 306A-306N are further embodiments of subordinate slices 112A-112N of FIG. 1, and, for the purposes of illustration for FIG. 3A, are configured the same, or substantially the same as subordinate slices 112A-112N above. Subordinate slices 306A-306N receive respective sub-task instructions 362A-362N from coordinator slice 304 and provide corresponding responses 364A-364N, each indicative of the corresponding subordinate slice having completed a respective sub-task.

Subordinate slices may be configured in various ways. For instance, FIG. 3B is a block diagram of subordinate slice 306A shown in the example processing system 380 of FIG. 3A. Subordinate slice 306A includes an interface 368, a slice controller 370, a command queue 372, response and communication registers 374, execution engines 376, and data buffers 378. Interface 368, slice controller 370, command queue 372, response and communication registers 374, execution engines 376, and data buffers 378 may be configured to perform respective functions similar to the functions of interface 308, slice controller 310, command queue 330, response and communication registers 316, execution engines 318, and data buffers 320 of coordinator slice 304 as described above with respect to FIG. 3A.

For example, as illustrated in FIG. 3B, interface 368 of subordinate slice 306A receives sub-task instructions 362A from coordinator slice 304. Command queue 372 receives sub-task instructions 362A via command bus 382. When sub-task instructions 362A are the next in the queue of commands, execution engines 376 receive the sub-task instructions 362A from command queue 372 via instruction bus 388. Execution engines 376 may access responses and communications from other allocated accelerator slices via response bus 390 and access data stored in data buffers 378 via execution data bus 394. Execution engines 376 generates a response 364A, which is transmitted to coordinator slice 304 of FIG. 3B or processor core 102 of FIG. 1, depending on the particular implementation.

While subordinate slice 306A is illustrated in FIG. 3B with components for performing sub-tasks, it is contemplated herein that subordinate slices may include additional components, not shown in FIG. 3B for brevity and illustrative clarity. For instance, a subordinate slice may include a command manager and slice coordinator such as command manager 312 and slice coordinator 314 of FIG. 3B. In this context, the subordinate slice may be configured to perform functions similar to coordinator slice 304.

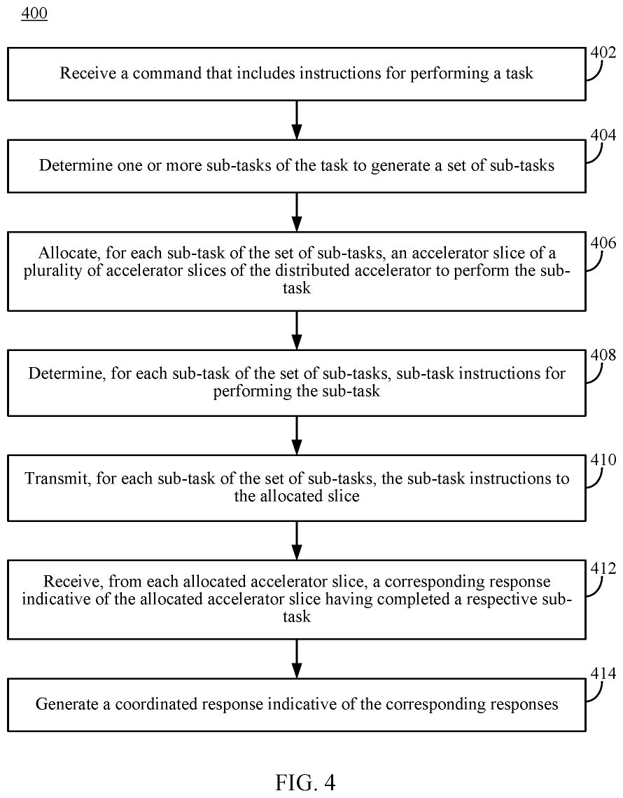

Note that coordinator slice 304 as illustrated in FIG. 3A may operate in various ways, in embodiments. For instance, FIG. 4 is a flowchart 400 of a process for coordinating sub-tasks among a plurality of accelerator slices, according to an example embodiment. In an embodiment, coordinator slice 304 may be configured to perform one or all of the steps of flowchart 400. Flowchart 400 is described as follows with respect to processing system 100 of FIG. 1 and distributed accelerator 300 of FIG. 3A. Further structural and operational embodiments will be apparent to persons skilled in the relevant art(s) based on the following description. Note that not all steps of flowchart 400 need to be performed in all embodiments.

Flowchart 400 starts with step 402. In step 402, a command that includes instructions for performing a task is received. For instance, coordinator slice 304 of FIG. 3A receives command 360 from processor core 102 of FIG. 1. Command 360 includes instructions for performing a task. Coordinator slice 304 may place command 360 in a queue of commands. For instance, command manager 312 of coordinator slice 304 is configured to place command 360 in command queue 330. Commands may be placed in command queue 330 based on a priority level, time to complete, time received by coordinator slice 304, or other criteria described herein.

In step 404, one or more sub-tasks of the task are determined to generate a set of sub-tasks. For instance, sub-task generator 332 of FIG. 3A is configured to determine one or more sub-tasks of the task received in step 402. Sub-tasks may be determined in various ways. For instance, a task may be divided based on bandwidth needed to complete a task, size of data to be moved or manipulated, types of steps to be performed, or as described elsewhere herein.

In step 406, for each sub-task of the set of the set of sub-tasks, an accelerator slice of a plurality of accelerator slices of the distributed accelerator is allocated to perform the sub-task. For instance, slice allocator 334 of FIG. 3A is configured to allocate accelerator slices of distributed accelerator 300 to perform the set of sub-tasks generated in step 404. Slice allocator 334 is configured to allocate one or more of coordinator slice 304 and/or subordinate slices 306A-306N. Accelerator slices may be allocated based on the type of sub-task to be performed, the type of accelerator slice, the latency of the sub-task, the load of the accelerator slice, or other factors described elsewhere herein. In embodiments, slice allocator 334 may allocate a single sub-task or multiple sub-tasks to each allocated accelerator slice.

In step 408, for each sub-task of the set of the set of sub-tasks, sub-task instructions are determined for performing the sub-task. For instance, sub-instruction generator 336 of FIG. 3A is configured to generate sub-task instructions for each sub-task of the set of sub-tasks generated by sub-task generator 332 in step 404.

In step 410, for each sub-task of the set of the set of sub-tasks, the sub-task instructions are transmitted to the allocated slice. For instance, slice coordinator 314 of FIG. 3A is configured to transmit sub-task instructions generated by sub-instruction generator 336 in step 408 to accelerator slices allocated by slice allocator 334 in step 406. For example, slice coordinator 314 transmits sub-task instructions for sub-tasks allocated to coordinator slice 304 to execution engines 318 via engine instruction bus 350 and transmits sub-task instructions for sub-tasks allocated to subordinate slices 306A-306N to response and communication registers 316 via subordinate instruction bus 352. Coordinator slice 304 is configured to transmit sub-task instructions for sub-tasks allocated to subordinate slices 306A-306N via interface 308.

In step 412, a corresponding response is received from each allocated accelerator slice. Each corresponding response is indicative of the allocated accelerator slice having completed a respective sub-task. For instance, coordinated response generator 326 of coordinator slice 304 of FIG. 3A receives corresponding responses from each allocated accelerator slice via configuration and status bus 346. For example, if coordinator slice 304 was allocated to a sub-task in step 406, a corresponding response from coordinator slice 304 is generated by execution engines 318 and transmitted to coordinated response generator 326 via configuration and status bus 346. If one or more subordinate slices 306A-306N were allocated to a sub-task in step 406, corresponding responses 364A-N are received by interface 308 and stored in response and communication registers 316. Execution engines 318 receive stored corresponding responses 364A-N via response bus 354 and transmit corresponding responses 364A-N to coordinated response generator 326 via configuration and status bus 346.

In step 414, a coordinated response indicative of the corresponding responses is generated. For instance, coordinated response generator 326 is configured to generate a coordinated response 366 indicative of the corresponding responses received in step 412. Coordinated response 366 may be stored in response and communication registers 316. In embodiments, coordinated response 366 may be transmitted to processor core 102 in various ways, as described elsewhere herein.

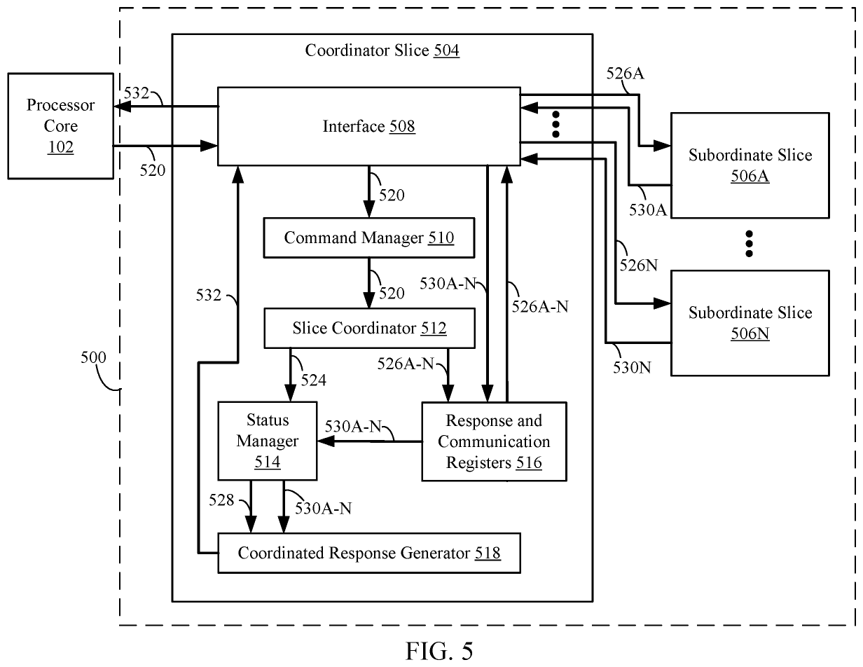

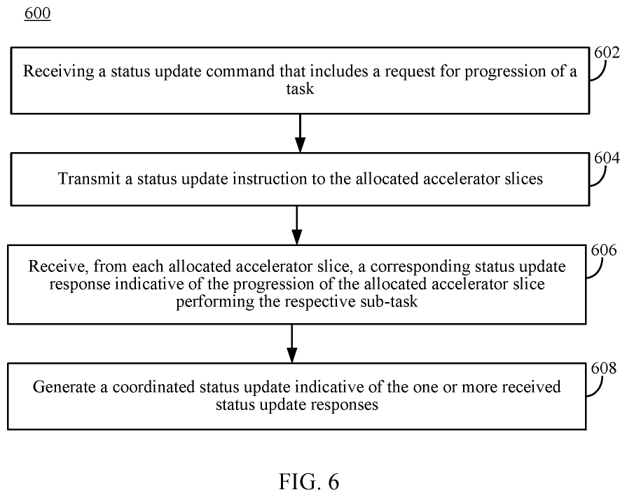

In embodiments, distributed accelerator 300 of FIG. 3A may operate in various ways. For instance, distributed accelerator 300 may generate a coordinated status update. For example, FIG. 5 is a block diagram of a processing system 550 that includes processor core 102 and a distributed accelerator 500 configured to generate a coordinated status update, according to an example embodiment. Distributed accelerator 500 is a further embodiment of distributed accelerator 300. Distributed accelerator 500 includes a coordinator slice 504 and subordinate slices 506A-506N. Coordinator slice 504 is a further embodiment of coordinator slice 304 and, as illustrated in FIG. 5, includes an interface 508, a command manager 510, a slice coordinator 512, a status manager 514, response and communication registers 516, and a coordinated response generator 518. Interface 508 is an example of interface 308, command manager 510 is an example of command manager 312, slice coordinator 512 is an example of slice coordinator 314, status manager 514 is an example of status manager 322, response and communication registers 516 are examples of response and communication registers 316, and coordinated response generator 518 is an example of coordinated response generator 326. For purposes of illustration, distributed accelerator 500 is described with respect to FIG. 6. FIG. 6 is a flowchart 600 of a process for generating a coordinated status update, according to an example embodiment. In an embodiment, coordinator slice 504 may be configured to perform one or all of the steps of flowchart 600. Distributed accelerator 500 and flowchart 600 are described as follows. Further structural and operational embodiments will be apparent to persons skilled in the relevant art(s) based on the following description. Note that steps of flowchart 600 may be performed in an order different than shown in FIG. 6 in some embodiments. Furthermore, not all steps of flowchart 600 need to be performed in all embodiments.

Flowchart 600 begins with step 602. In step 602, a status update command that includes a request for progression of a task is received. For example, interface 508 of coordinator slice 504 receives a status update command 520 from processor core 102. Interface 508 may store status update command 520 in a register, convert status update command 520 to another format, and/or otherwise process status update command 520, depending on the particular implementation. Command manager 510 receives status update command 520 from interface 508. Command manager 510 may process status update command 520 in various ways. For instance, command manager 510 may place status update command 520 in a command queue (e.g., command queue 330 of FIG. 3A), bypass the command queue, or notify a slice controller of coordinator slice 504 (e.g., slice controller 310 of FIG. 3A).

In step 604, a status update instruction is transmitted to the allocated accelerator slices. For instance, slice coordinator 512 is configured to transmit status update instructions to allocated accelerator slices based on status update command 520. For example, slice coordinator 512 receives status update command 520 from command manager 510. Slice coordinator 512 determines sub-tasks associated with status update command 520 and accelerator slices allocated to determined sub-tasks. If coordinator slice 504 is an allocated accelerator slice, slice coordinator 512 transmits a status update instruction 524 to status manager 514. If one or more subordinate slices 506A-506N are allocated accelerator slices, slice coordinator 512 stores one or more status update instructions 526A-N in response and communication registers 516. Interface 508 receives one or more status update instructions 526A-N from response and communication registers 516 and transmits the instructions to corresponding subordinate slices 506A-506N.

In step 606, a corresponding status update response is received from each allocated accelerator slice. Each corresponding status update is indicative of the progression of the allocated accelerator slice performing the respective sub-task. For instance, coordinated response generator 518 is configured to receive a corresponding status update from each allocated accelerator slice. For example, if coordinator slice 504 is an allocated accelerator slice, status manager 514 receives status update instruction 524, determines the progression of coordinator slice 504 in performing the respective sub-task, and generates corresponding status update 528. If one or more of subordinate slices 506A-506N are allocated accelerator slices, the allocated accelerator slices receive respective status update instructions 526A-N, determine the progression of respective sub-tasks, and generate corresponding status updates 530A-N. Interface 508 of coordinator slice 504 receives corresponding status updates 530A-N and stores the updates in response and communication registers 516. Status manager 514 receives corresponding status updates 530A-N from response and communication registers 516. In accordance with an embodiment, status manager 514 is configured to evaluate or otherwise process corresponding status updates 530A-N. For instance, status manager 514 may check for errors in corresponding status updates 530A-N. Coordinated response generator 518 is configured to receive corresponding status update 528 and corresponding status updates 530A-N from status manager 514.

In step 608, a coordinated status update indicative of the one or more received status update responses is generated. For instance, coordinated response generator 518 is configured to generate a coordinated status update 532 indicative of corresponding status updates 528 and 530A-N. In accordance with an embodiment, coordinated response generator 518 stores coordinated status update 532 in a register of interface 508, e.g., a status register. Processor core 102 may receive coordinated response generator 518 from coordinator slice 504 asynchronously or synchronously, as described elsewhere herein.

Thus, a process for generating a coordinated status update has been described with respect to FIGS. 5 and 6. While FIGS. 5 and 6 illustrate a process for generating a coordinated status update in response to a status update command, it is contemplated herein that distributed accelerator 500 may be configured to generate coordinated status updates automatically, periodically, in response to changes in operating conditions of coordinator slice 504 and/or subordinate slices 506A-506N, and/or the like. Coordinated status updates may include status of incomplete sub-tasks, allowing a program to resume operation either in software or issuing a refactored command to a distributed accelerator. While FIG. 5 illustrates a coordinator slice 504 coordinating status updates of allocated accelerator slices, it is contemplated herein that each accelerator slice may individually transmit a status update to processor core 102.

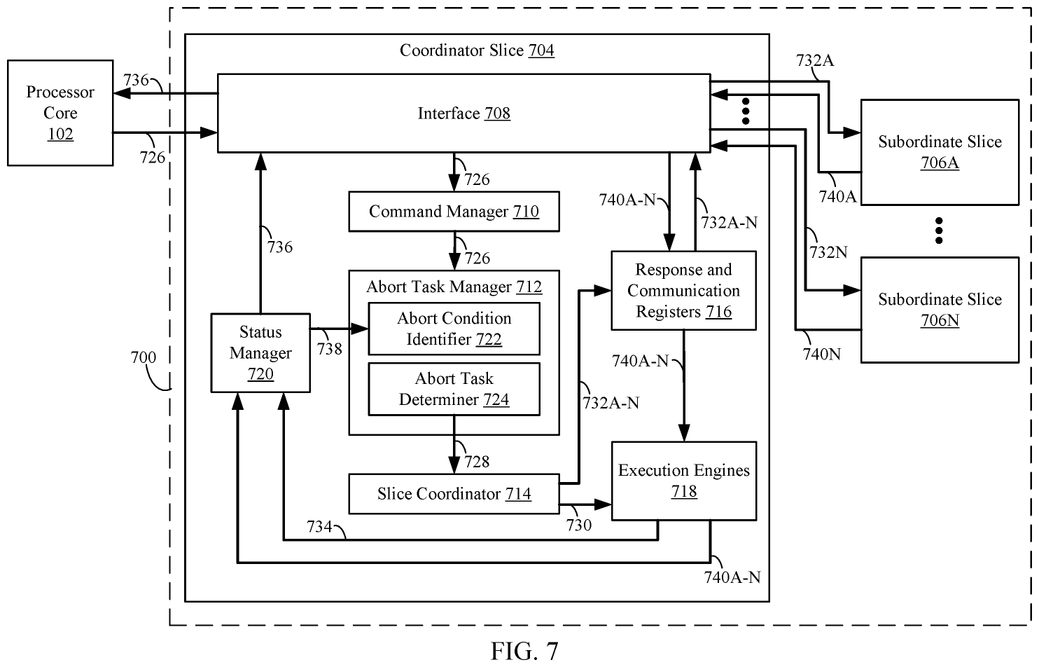

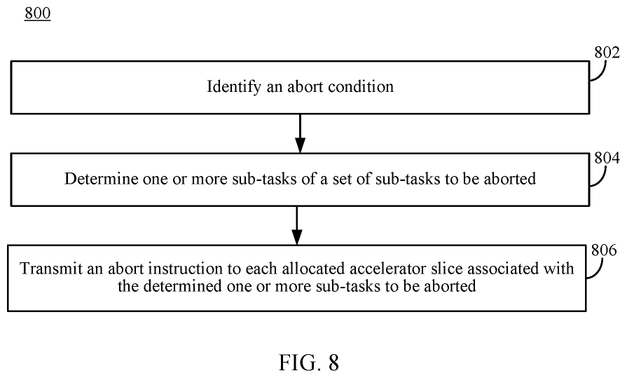

In embodiments, distributed accelerator 300 of FIG. 3A may be configured to abort one or more sub-tasks. For example, FIG. 7 is a block diagram of a processing system 750 that includes processor core 102 and a distributed accelerator 700 configured to abort one or more sub-tasks, according to an example embodiment. Distributed accelerator 700 is a further embodiment of distributed accelerator 300. Distributed accelerator 700 includes a coordinator slice 704 and subordinate slices 706A-706N. Coordinator slice 704 is a further embodiment of coordinator slice 304 and, as illustrated in FIG. 7, includes an interface 708, a command manager 710, an abort task manager 712, a slice coordinator 714, response and communication registers 716, execution engines 718, and a status manager 720. Interface 708 is an example of interface 308, command manager 710 is an example of command manager 312, abort task manager 712 is an example of abort task manager 324, slice coordinator 714 is an example of slice coordinator 314, response and communication registers 716 are examples of response and communication registers 316, execution engines 718 are examples of execution engines 318, and status manager 720 is an example of status manager 322. Abort task manager 712 includes an abort condition identifier 722 and an abort task determiner 724. For purposes of illustration, distributed accelerator 700 is described with respect to FIG. 8. FIG. 8 is a flowchart 800 of a process for aborting one or more sub-tasks, according to an example embodiment. In an embodiment, coordinator slice 704 may be configured to perform one or all of the steps of flowchart 800. Distributed accelerator 700 and flowchart 800 are described as follows. Further structural and operational embodiments will be apparent to persons skilled in the relevant art(s) based on the following description. Note that steps of flowchart 800 may be performed in an order different than shown in FIG. 8 in some embodiments. Furthermore, not all steps of flowchart 800 need to be performed in all embodiments.

Flowchart 800 begins at step 802. In step 802, an abort condition is identified. For instance, abort condition identifier 722 is configured to identifier an abort condition. An abort condition may be an abort command, an error in the operation of distributed accelerator 700, or another condition for aborting one or more sub-tasks performed by distributed accelerator 700. For instance, in accordance with an embodiment, interface 708 of coordinator slice 704 receives an abort command 726 from processor core 102 of FIG. 1. Interface 708 may store abort command 726 in a register, convert abort command 726 to another format, and/or otherwise process abort command 726, depending on the particular implementation. Command manager 710 receives abort command 726 from interface 708. Command manager 710 may process abort command 726 in various ways. For instance, command manager 710 may place abort command 726 in a command queue (e.g., command queue 330 of FIG. 3A), bypass the command queue, or notify a slice controller of coordinator slice 704 (e.g., slice controller 310 of FIG. 3A). Abort task manager 712 receives abort command 726 from command manager 710. Abort condition identifier 722 is configured to confirm abort command 726 is an abort condition.

In accordance with an embodiment, abort condition identifier 722 is configured to identify an abort condition by identifying an error in the operation of distributed accelerator 700. The error may be detected in the coordinator slice 704 or one or more of subordinate slices 706A-706N. For instance, status manager 720 is configured to monitor the operation status of execution engines 718 via engine status signals 734 and subordinate slices 706A-706N via subordinate status signals 740A-740N. Status manager 720 may generate a status indication signal 738 indicative of the operation status of execution engines 718 and/or subordinate slices 706A-706N. Abort condition identifier 722 is configured to determine if status indication signal 738 indicates an abort condition. For instance, abort condition identifier 722 may determine that status indication signal 738 indicates a failure in the operation of execution engines 718, another component of coordinator slice 704, one or more of subordinate slices 706A-706N, communication between coordinator slice 704 and subordinate slices 706A-706N, and/or the like.

In accordance with an embodiment, abort condition identifier 722 may determine an exception has occurred. An exception is an error that an accelerator slice is unable to resolve. For instance, an exception may occur due to a fault in the accelerator slice, an error in data associated with a sub-task, a communication error, or other error condition in performing a sub-task. Coordinator slice 704 may reallocate a sub-task that resulted in an exception to another accelerator slice of distributed accelerator 700 or report the exception to processor core 102 for processing. For instance, an exception resulting from a page fault may be reported to processor core 102 for handling as a regular page fault.

In step 804, one or more sub-tasks of a set of sub-tasks are determined to be aborted. For instance, abort task determiner 724 is configured to determine one or more sub-tasks to be aborted based on the abort condition identified in step 806. Abort task determiner is further configured to generate an abort set signal 728 indicative of the one or more sub-tasks to be aborted. A sub-task may be identified by a CID, an allocated accelerator slice, a type of sub-task, and/or other criteria described herein. For instance, abort command 726 may include the CID of a command to be aborted. In this context, abort task determiner 724 determines to abort each sub-task associated with the CID.

In step 806, an abort instruction is transmitted to each allocated accelerator slice associated with the determined one or more sub-tasks to be aborted. For instance, slice coordinator 714 transmits abort instructions to each allocated accelerator slice associated with the one or more sub-tasks to be aborted determined in step 804. For example, slice coordinator 714 receives abort set signal 728 from abort task determiner 724. Slice coordinator 714 determines which accelerator slices are allocated to the one or more sub-tasks to be aborted. If coordinator slice 704 is allocated to a sub-task to be aborted, slice coordinator 714 transmits an abort instruction 730 to execution engines 718. If one or more of subordinate slices 706A-706N are allocated to a sub-task to be aborted, slice coordinator 714 stores abort instructions 732A-N in response and communication registers 716. Interface 708 receives abort instructions 732A-N from response and communication registers 716 and transmits abort instructions 732A-N to corresponding subordinate slices 706A-706N.

In accordance with an embodiment, distributed accelerator 700 is configured to update processor core 102 after one or more sub-tasks have been aborted. For instance, status manager 720 is configured to monitor the operation status of execution engines 718 via engine status signals 734 and subordinate slices 706A-706N via subordinate status signals 740A-740N. Status manager 720 generates an abort complete signal 736 indicative of each sub-task determined in step 804 has been aborted. Abort complete signal 736 may include data such as which accelerator slices were aborted, progress of aborted sub-tasks, data associated with aborted sub-tasks, abort condition identified in step 802, and/or the like. For example, in accordance with an embodiment, abort complete signal 736 includes states of aborted tasks and/or sub-tasks. In this example, processor core 102 receives abort complete signal 736 and utilizes the states of aborted tasks and/or sub-tasks for debugging and/or resuming aborted tasks.

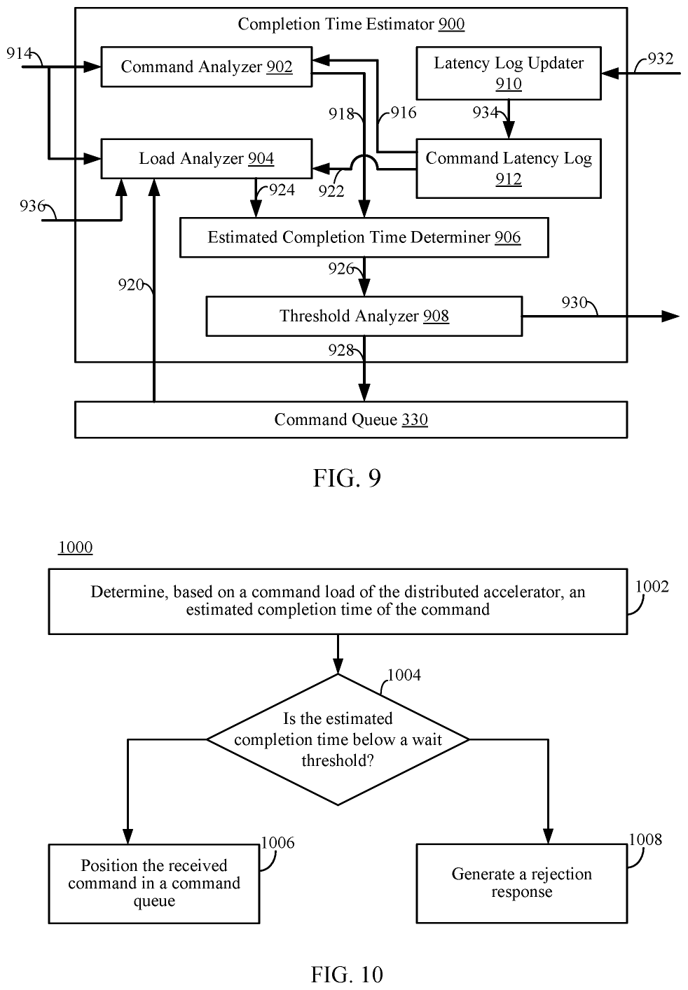

In embodiments, completion time estimator 328 of FIG. 3A may be configured to operate in various ways. For example, FIG. 9 is a block diagram of a completion time estimator 900 corresponding to completion time estimator 328 shown in the example distributed accelerator 300 of FIG. 3A. Completion time estimator 900 includes a command analyzer 902, a load analyzer 904, an estimated completion time determiner 906, a threshold analyzer 908, a latency log updater 910, and a command latency log 912. For purposes of illustration, completion time estimator 900 is described with respect to FIG. 10. FIG. 10 is a flowchart of a process for evaluating an estimated completion time of a command, according to an example embodiment. In an embodiment, completion time estimator 900 may be configured to perform one or all of the steps of flowchart 1000. Completion time estimator 900 and flowchart 1000 are described as follows. Further structural and operational embodiments will be apparent to persons skilled in the relevant art(s) based on the following description. Note that steps of flowchart 1000 may be performed in an order different than shown in FIG. 10 in some embodiments. Furthermore, not all steps of flowchart 1000 need to be performed in all embodiments.

Flowchart 1000 starts with step 1002. In step 1002, an estimated completion time of a command is determined based on a command load of the distributed accelerator. For instance, completion time estimator 900 receives a command 914 from a processor, such as processor 102 of FIG. 1. Command analyzer 902 is configured to analyze command 914. For example, command analyzer 902 may determine resources needed to complete the task associated with command 914, the time it would take for distributed accelerator 300 of FIG. 3A to complete the task, and/or the like. In accordance with an embodiment, command analyzer 902 receives command latency information 916 from command latency log 912. Command latency information 916 includes data estimating the latency of command 914. For example, command analyzer 902 may determine command 914 includes a cyclic redundance check (CRC) task and retrieve command latency information 916 indicative of an estimated latency to perform a CRC task. Command analyzer 902 generates a command analysis signal 918 based on the analysis of command 914.

Load analyzer 904 is configured to analyze a current workload of distributed accelerator 300. For instance, load analyzer 904 is configured to receive status signal 936 from status manager 322 (not shown in FIG. 3A) and queue information 920 from command queue 330. Status signal 936 indicates a current status of sub-tasks performed by allocated accelerator slices of distributed accelerator 300. Queue information 920 includes a list of commands in command queue 330 and may include data associated with each command, such as command latency, command prioritization, resources required, buffer sizes, and/or the like. In accordance with an embodiment, load analyzer 904 receives queued command latency information 922 from command latency log 912. Queued command latency information 922 includes data estimating the latency of commands in command queue 330. Load analyzer generates a load analysis signal 924 based on the analysis of status signal 936 and queue information 920.

Estimated completion time determiner 906 is configured to receive command analysis signal 918 from command analyzer 902 and load analysis signal 924 from load analyzer 904. Estimated completion time determiner 906 determines an estimated completion time of the task associated with command 914 based on command analysis signal 918 and load analysis signal 924. For instance, estimated completion time determiner 906 may analyze resources available to perform the task associated with command 914, commands queued in command queue 330, estimated completion time of queued commands, command latencies, and other data to generate an estimated completion time 926.

In step 1004, the estimated completion time is compared to a wait threshold. For instance, threshold analyzer 908 receives estimated completion time 926 and compares it to a wait threshold. In accordance with an embodiment, the wait threshold is included with command 914. For example, processor 102 may include a wait threshold indicative of a deadline to complete the task associated with command 914. In accordance with another embodiment, the wait threshold is a predetermined threshold. For instance, the wait threshold may be a maximum number of clock cycles after command 914 was received by completion time estimator 900. If estimated completion time 926 is below the wait threshold, flowchart 1000 proceeds to step 1006. Otherwise, flowchart 1000 proceeds to step 1008. It is contemplated herein that, if estimated completion time 926 is at the wait threshold, flowchart 1000 may proceed to either step 1006 or step 1008, depending on the particular implementation.

In step 1006, the received command is positioned in a command queue. For instance, threshold analyzer 908 is configured to generate, if estimated completion time 926 is below the wait threshold, a positioning signal 928. Positioning signal 928 includes command 914. Depending on the particular implementation, positioning signal 928 may include additional information such as command latency, estimated completion time 926, buffer size, and other information related to command 914. Command queue 330 receives positioning signal 928 and positions command 914 accordingly. In accordance with an embodiment, positioning signal 928 includes instructions to position command 914 in a particular position of command queue 330. For instance, positioning signal 928 may include instructions to position command 914 at the beginning of command queue 330, at the end of command queue 330, before or after a particular command in command queue 330, and/or the like.

In step 1008, a rejection response is generated. For instance, threshold analyzer 908 is configured to generate, if estimated completion time is at or above the wait threshold, a rejection response 930. Rejection response 930 may be stored in a register, such as response and communication registers 316 of FIG. 3A. In accordance with an embodiment, rejection response 930 is transmitted to the processor that issued command 914 (e.g., processor 102 of FIG. 1) as an interrupt.

As stated above, completion time estimator 900 includes a latency log updater 910 and command latency log 912. Latency log updater 910 and command latency log 912 may enable dynamic command latency estimation. For instance, in accordance with an embodiment, status manager 322 of distributed accelerator 300 of FIG. 3A notes a start time of a command processed by distributed accelerator 300. In this example, status manager 322 is configured to generate a completed command latency signal 932 when the command is completed by distributed accelerator 300 of FIG. 3A. Completed command latency signal 932 may include information such as the total time to complete the command, a number of resources to complete a command, total time to complete sub-tasks, resources used to complete sub-tasks, and/or other information associated with the completed command. Latency log updater 910 receives completed command latency signal 932 from status manager 322 and generates a latency log update signal 934 to update command latency log 912. Linear regression models or machine learning models may be combined with queueing models to estimate completion times for a particular command.

### III. Example Coordinator Slice Embodiments

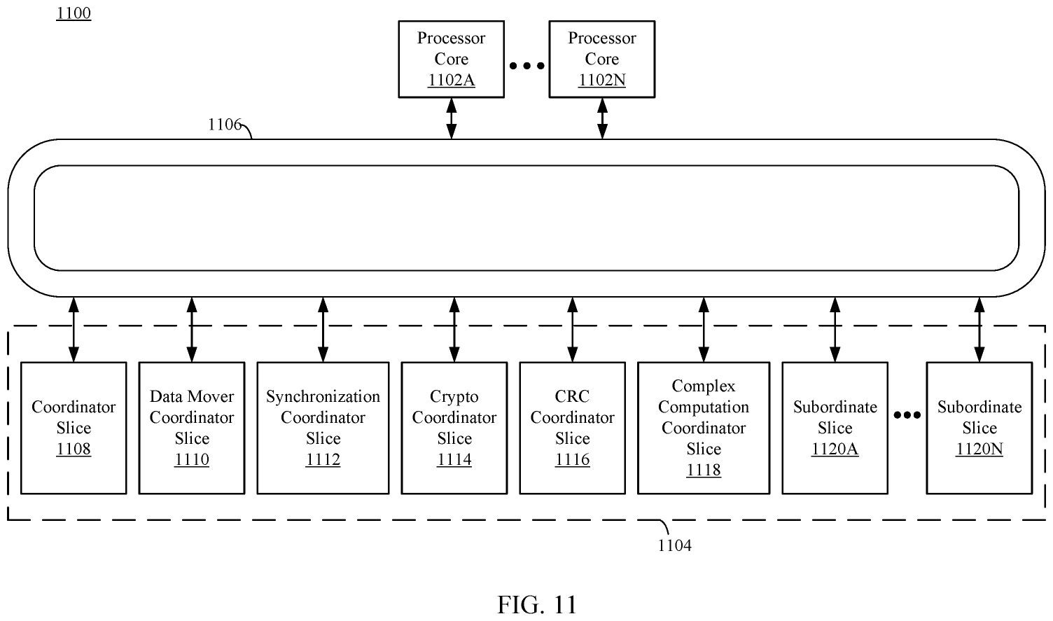

Coordinator slices may be configured in various ways, in embodiments. For instance, a coordinator slice may include hardware and/or firmware specialized for performing particular tasks. Coordinator slices specialized for performing different tasks may be included in the same distributed accelerator. For example, FIG. 11 is a block diagram of a processing system 1100 including a various types of coordinator slices, according to an example embodiment. Processing system 1100 is a further embodiment of processing system 200 of FIG. 2. Further structural and operational examples will be apparent to persons skilled in the relevant art(s) based on the following descriptions. Processing system 1100 is described as follows with respect to processing system 200.

Processing system 1100 includes processor cores 1102A-1102N and distributed accelerator 1104. Processor cores 1102A-1102N and distributed accelerator 1104 are communicatively coupled by interconnect 1106. Processor cores 1102A-1102N and interconnect 1106 are further embodiments of processor cores 202A-202N and interconnect 224 of FIG. 2, respectively, and, for the purposes of illustration of FIG. 11, are configured the same, or substantially the same, as processor cores 202A-202N and interconnect 224 above. That is, processor cores 1102A-1102N are configured to send commands to and receive responses from distributed accelerator 1104 via interconnect 1106.

Distributed accelerator 1104 is a further embodiment of distributed accelerator 210 of FIG. 2. Distributed accelerator 1104 includes a coordinator slice 1108, a data mover coordinator slice 1110, a synchronization coordinator slice 1112, a crypto coordinator slice 1112, a cyclic redundancy check (CRC) coordinator slice 1116, a complex computation coordinator slice 1118, and subordinate slices 1120A-1120N. Coordinator slice 1108 and subordinate slices 1120A-1120N are further embodiments of coordinator slice 212 and subordinate slices 214A-214N, subordinate slices 216A-216N, and subordinate slices 218A-218N, respectively, and, for the purposes of illustration of FIG. 11, are configured the same, or substantially the same, as coordinator slice 212 and subordinate slices 214A-214N, subordinate slices 216A-216N, and subordinate slices 218A-218N above. That is, coordinator slice 212 is configured to perform sub-tasks and coordinate sub-tasks among accelerator slices of distributed accelerator 1104. Subordinate slices 218A-218N are configured to perform allocated sub-tasks and generate responses. Each of data mover coordinator slice 1110, synchronization coordinator slice 1112, crypto coordinator slice 1114, CRC coordinator slice 1116, and complex computation coordinator slice 1118 may be configured similar to coordinator slice 1108, and are configured to coordinate sub-tasks among accelerator slices of distributed accelerator slices 1104 and to perform specialized tasks.

For instance, data mover coordinator slice 1110 is configured to perform data movement sub-tasks, such as copying a data buffer to another memory location, initializing memory with a data pattern, comparing two memory regions to produce a difference in a third data buffer, computing and appending checksum to a data buffer, applying previously computed differences to a buffer, move data in a buffer to a different cache level (e.g., L2, L3, or L4), and/or other data movement functions as would be understood by a person of skill in the relevant art(s) having benefit of this disclosure. For instance, data mover coordinator slice 1110, in accordance with an embodiment, is configured to coordinate data movement tasks requiring large bandwidths. Data mover coordinator slice 1110 may allocate accelerator slices of distributed accelerator 1104 to move portions of data associated with a data movement task. In this way, data movement traffic is distributed across processing system 1100, reducing hotspots in communication traffic (e.g., interconnect traffic, IO interface traffic, controller interface traffic). In accordance with an embodiment, data mover coordinator slice 1110 may include a coherence engine to perform data transfer within memory of processing system 1100.

Synchronization coordinator slice 1112 is configured to accelerate atomic operations to operate on small amounts of data (e.g., a few words of data). Synchronization coordinator slice 1112 may perform an atomic update of a variable, an atomic exchange of two variables based on the value of a third, and/or perform other synchronization functions, as would be understood by a person of skill in the relevant art(s) having benefit of this disclosure. Synchronization coordinator slice 1112 is configured to return data values in addition to task statuses. In accordance with an embodiment, synchronization coordinator slice 1112 may store a final result in a local cache of a processor core (e.g., one or more of processor cores 1102A-1102N).

Crypto coordinator slice 1114 is configured to perform cryptography sub-tasks, such as implementing encryption and decryption functions. Encryption and decryption functions may be based on various standards. Cryptography coordinator slice 1114 may be configured to encrypt and/or decrypt data used by other accelerator slices of distributed accelerator 1104. CRC coordinator slice 1116 is configured to perform CRC sub-tasks. For instance, CRC coordinator slice 1116 may detect errors in data or communication between components of processing system 1100.

Complex computation coordinator slice 1118 is configured to perform complex computations. Complex computation coordinator slice 1118 may be configured to perform complex computations alone or in coordination with other accelerator slices of distributed accelerator 1104. For instance, complex computation coordinator slice 1118 may include hardware and/or firmware specialized for performing encryption and data movement tasks. In this context, complex computation coordinator slice 1118 may perform tasks including encryption and data movement sub-tasks. In another embodiment, complex computation coordinator slice 1118 includes hardware and/or firmware for managing data coherence and receives a data movement command. In this example, complex computation coordinator slice 1118 allocates itself for managing coherence of the data movement and data mover coordinator slice 1110 for moving data.

Processing system 1100 may include additional components not shown in FIG. 2 for brevity and illustrative clarity. For instance, processing system 1100 may include cache controllers such as cache controllers 204A-204N, memory controllers such as memory controllers 206A-206N, and IO controllers such as IO controllers 208A-208N of FIG. 2. One or more accelerator slices of distributed accelerator 1104 may be included within or communicatively coupled to one or more of these additional components. For example, data mover coordinator slice 1110 may be implemented in memory controller 206A. In this context, data mover coordinator slice 1110 is configured to perform sub-tasks related to memory stored in memory managed by memory controller 206A. Synchronization coordinator slice 1112 may be implemented in a cache controller such as cache controller 204A to perform tasks related to data stored in cache 222A. It is contemplated herein that any of the accelerator slices of distributed accelerator 1104 may be implemented in any component of processing system 1100, as an on-chip component of processing system 1100, as an off-chip component coupled to processing system 1100 (e.g., via an IO controller), or otherwise configured to accelerate tasks of processing system 1100, as described elsewhere herein. Furthermore, it is contemplated herein that any one of coordinator slice 1108, data mover coordinator slice 1110, synchronization coordinator slice 1112, crypto coordinator slice 1114, CRC coordinator slice 1116, and/or complex coordinator slice 1116 may be allocated as a subordinate slice to another coordinator slice, depending on the particular implementation. Moreover, it is contemplated herein that distributed accelerator 1104 may include other types of accelerator slices for performing other data processing functions, as described elsewhere herein and/or as would be understood by a person of skill in the relevant art(s) having benefit of this disclosure.

Data mover coordinator slice 1110 may operate in various ways to move data, in embodiments. For example, FIG. 12 is a block diagram of a processing system 1200 for performing a data movement process, according to an example embodiment. Processing system 1200 is a further embodiment of processing system 1100 of FIG. 11. Processing system 1200 includes processor core 1202, data mover coordinator slice 1204, data mover subordinate slice 1206, and data mover subordinate slice 1208. Processor core 1202 is an example of processor cores 1102A-1102N, data mover coordinator slice 1204 is an example of data mover coordinator slice 1110, and data mover subordinate slices 12106 and 1208 are examples of subordinate slices 1120A-1120N. For purposes of illustration, processing system 1200 is described with respect to FIG. 13. FIG. 13 is a flowchart 1300 of a process for moving data, according to an example embodiment. In an embodiment, data mover coordinator slice 1204 may be configured to perform one or all of the steps of flowchart 1300. Processing system 1200 and flowchart 1300 are described as follows. Further structural and operational embodiments will be apparent to persons skilled in the relevant art(s) based on the following description. Note that steps of flowchart 1300 may be performed in an order different than shown in FIG. 13 in some embodiments. Furthermore, not all steps of flowchart 1300 need to be performed in all embodiments.

Flowchart 1300 begins with step 1302. In step 1302, a set of portions of data are determined. For instance, processor core 1202 generates a data movement command 1210 including instructions to move data from a first location to a second location. Data mover coordinator slice 1204 receives data movement command 1210 and determines a set of portions of the data. Data mover coordinator slice 1204 may separate the data into multiple portions based on the size of data to be moved, bandwidth of available accelerator slices, the number of accelerator slices that may be allocated to move data, location of accelerator slices, location of data to be moved, and/or other criteria described elsewhere herein. For instance, in a non-limiting example, data movement command 1210 includes instructions to move 30 MBs of data. Data mover coordinator slice 1204 separates the 30 MBs of data into three 10 MB portions of data.

In step 1304, for each portion of the set of portions of the data, a sub-task for moving the portion is determined. For instance, data mover coordinator slice 1204 determines, for each portion of the set of portions of the data determined in step 1302, a sub-task for moving the portion. Determined sub-tasks may be transmitted to allocated accelerator slices, as described with respect to steps 406-410 of flowchart 400 of FIG. 4 above. Continuing the non-limiting example described above with respect to step 1302, data mover coordinator slice 1204 determines three sub-tasks, each for moving a respective 10 MB portion of data.

As illustrated in FIG. 12, data mover coordinator slice 1204 is configured to further perform functions related to data movement command 1210. For instance, in continuing the non-limiting example described with respect to flowchart 1300, data mover coordinator slice 1204 allocates itself for moving the first 10 MB portion, data mover subordinate slice 1206 for moving the second 10 MB portion, and data mover subordinate slice 1208 for moving the third 10 MB portion. Data mover coordinator slice 1204 generates sub-task instructions for moving the first 10 MB portion (not shown in FIG. 12), sub-task instructions 1212 for moving the second 10 MB portion, and sub-task instructions 1214 for moving the third 10 MB portion. Each set of sub-task instructions may include read operations, write operations, coherency sub-tasks, and/or other instructions related to moving data, as would be understood by a person of skill in the relevant art(s) having benefit of this disclosure. Read and write operations may include a source address indicating a source of data, a destination address indicating a destination to write to, an indication of the size of data, and/or other information related to the data movement. Execution engines of data mover coordinator slice 1204 perform the sub-task for moving the first 10 MB portion. Sub-task instructions 1212 are transmitted to data mover subordinate slice 1206, which performs the sub-task for moving the second 10 MB portion and generates results 1216. Sub-task instructions 1214 are transmitted to data mover subordinate slice 1208, which performs the sub-task for moving the third 10 MB portion and generates results 1218. Data mover coordinator slice 1204 aggregates results from performing the sub-task for moving the first 10 MB portion, results 1216, and 1218 to generate a coordinated response 1220, indicating the data movement is complete.

Embodiments of data mover coordinator slices, such as data mover coordinator slice 1204 of FIG. 12, enable coordination of data movement processes across multiple accelerator slices. This distributes data movement across multiple devices, reducing hot spots in a processing system interconnect. For instance, accelerator slices may be allocated to move portions of data in a way that balances the load in system interconnects, such as interconnect 1106 of FIG. 11. FIG. 12 includes a single processor core 1202, however it is contemplated herein that multiple processor cores may be used. In this context, each processor core may communicate with a different data mover coordinator slice, or multiple processor cores may use the same data mover coordinator slice. Furthermore, multiple data mover coordinator slices may be used by the same processor core.

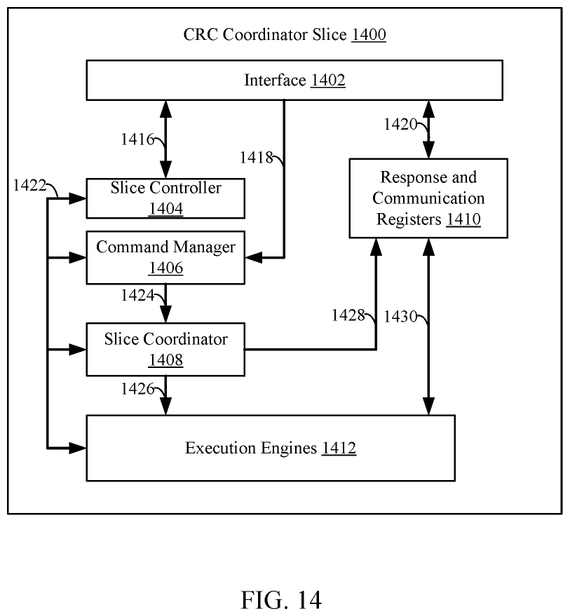

As described above, coordinator slices may include components similar to components of coordinator slice 304 of FIG. 3A; however, it is contemplated herein that types of coordinator slices may have additional components, may have modified components, or may not have certain components analogous to components of coordinator slice 304. For instance, FIG. 14 is a block diagram of a cyclic redundancy check (CRC) coordinator slice 1400, according to an example embodiment. CRC coordinator slice is a further embodiment of CRC coordinator slice 1116. Further structural and operational examples will be apparent to persons skilled in the relevant art(s) based on the following descriptions. CRC coordinator slice 1400 is described as follows with respect to coordinator slice 304 of FIG. 3A.

As illustrated in FIG. 14, CRC coordinator slice 1400 includes an interface 1402, a slice controller 1404, command manager 1406, slice coordinator 1408, response and communication registers 1410, and execution engines 1412. Interface 1402, slice controller 1404, command manager 1406, slice coordinator 1408, response and communication registers 1410, and execution engines 1412 are configured the same, or substantially the same, as interface 308, slice controller 310, command manager 312, slice coordinator 314, response and communication registers 316, and execution engines 318, respectively, with the following differences described further below.

In FIG. 14, CRC coordinator slice 1400 does not include a local data buffer. CRC coordinator slice 1400 is instead configured to fetch data a word at a time and compute a CRC in a response register. CRC coordinator slice 1400 may transmit the computed CRC to a processor core or to another accelerator slice (e.g., a subordinate slice) for further processing. While CRC coordinator slice 1400 is illustrated in FIG. 14 without data buffers, it is contemplated herein that coordinator slices with buffers may perform CRC tasks as well, depending on the particular implementation.

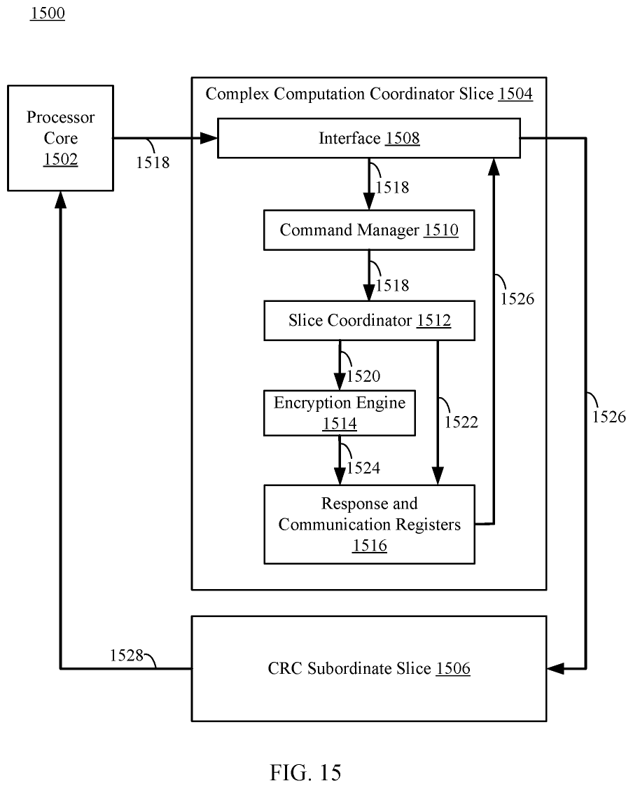

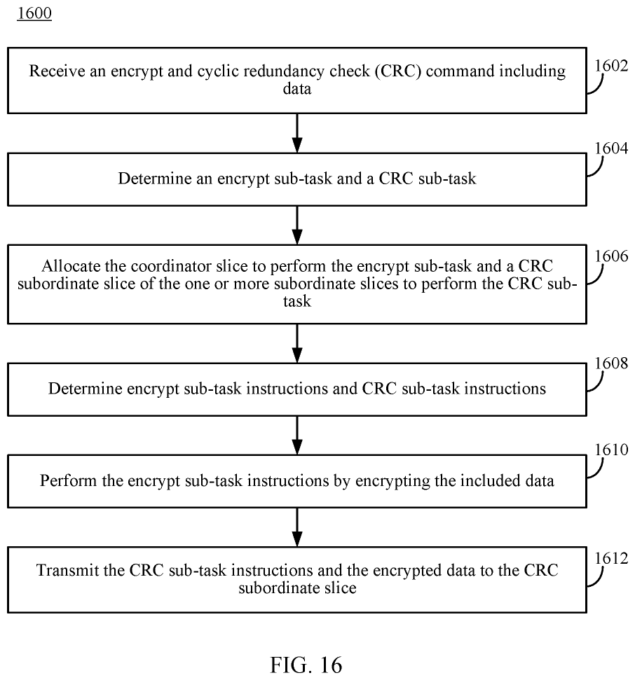

Distributed accelerators may be configured to perform complex computations in various ways, in embodiments. For example, FIG. 15 is a block diagram of a processing system 1500 for performing a complex computation, according to an example embodiment. Processing system 1500 is a further embodiment of processing system 1100 of FIG. 11. Processing system 1500 includes processor core 1502, complex computation coordinator slice 1504, and CRC subordinate slice 1506. Processor core 1502 is an example of processor cores 1102A-1102N, complex computation coordinator slice 1504 is an example of complex computation coordinator slice 1518, and CRC subordinate slice 1506 is an example of one of CRC coordinator slice 1116 or subordinate slices 1120A-1120N are examples of subordinate slices 1120A-1120N. Complex computation coordinator slice 1504 includes an interface 1508, a command manager 1510, a slice coordinator 1512, an encryption engine 1514, and response and communication registers 1516. Complex computation coordinator slice 1504 may include additional components, such as components similar to the components of coordinator slice 304 of FIG. 3A. For purposes of illustration, processing system 1500 is described with respect to FIG. 16. FIG. 16 is a flowchart 1600 of a process for performing a complex computation, according to an example embodiment. In an embodiment, complex computation coordinator slice 1504 may be configured to perform one or all of the steps of flowchart 1600. Processing system 1500 and flowchart 1600 are described as follows. Further structural and operational embodiments will be apparent to persons skilled in the relevant art(s) based on the following description. Note that steps of flowchart 1600 may be performed in an order different than shown in FIG. 16 in some embodiments. Furthermore, not all steps of flowchart 1600 need to be performed in all embodiments.

Flowchart 1600 begins with step 1602. In step 1602, an encrypt and CRC command including data is received. For instance, interface 1508 of complex computation coordinator slice 1504 receives encrypt and CRC command 1518. Interface 1508 may store the encrypt and CRC command 1518 in a register. In accordance with an embodiment, the included data is stored in a data buffer, not shown in FIG. 15. Command manager 1510 receives encrypt and CRC command 1518 and may be configured to perform functions similar to command manager 312 of FIG. 3A.

In step 1604, an encrypt sub-task and a CRC sub-task are determined. For instance, slice coordinator 1512 receives encrypt and CRC command 1518 and determines an encrypt sub-task and a CRC sub-task. Slice coordinator 1512 may determine the encrypt and CRC sub-tasks using a sub-task generator, such as sub-task generator 332 of FIG. 3A.

In step 1606, complex computation coordinator slice 1504 is allocated to perform the encrypt sub-task and CRC subordinate slice 1506 is allocated to perform the CRC sub-task. For instance, slice coordinator 1512 is configured to allocate complex computation coordinator slice 1504 to perform the encrypt sub-task and CRC subordinate slice 1506 to perform the CRC sub-task. Slice coordinator 1512 may allocate accelerator slices using a slice allocator, such as slice allocator 334 of FIG. 3A. It is contemplated herein that slice coordinator 1512 may allocate other accelerator slices to perform the encrypt sub-task and/or CRC sub-task. For instance, slice coordinator 1512 may allocate a crypto subordinate slice to perform the encrypt sub-task.

In step 1608, encrypt sub-task instructions and CRC sub-task instructions are determined. For instance, slice coordinator 1512 is configured to determine encrypt sub-task instructions 1520 and CRC sub-task instructions 1522. Slice coordinator 1512 may determine sub-task instructions using a sub-instruction generator, such as sub-instruction generator 336 of FIG. 3A. Slice coordinator 1512 transmits encrypt sub-task instructions 1520 to encryption engine 1514.

In step 1610, encrypt sub-task instructions are performed by encrypting the included data. For instance, encryption engine 1514 is configured to perform encrypt sub-task instructions 1520 by encrypting the data included in encrypt and CRC command 1518 to generate encrypted data 1524. Encryption engine 1514 may access included data from a register or data buffer of complex computation coordinator slice 1504. As illustrated in FIG. 15, encryption engine 1514 stores encrypted data 1524 in response and communication registers 1516, however it is contemplated herein that encryption engine 1514 may store encrypted data 1524 in another register or a data buffer of complex computation coordinator slice 1504.

In step 1612, the CRC sub-task instructions and the encrypted data are transmitted to the CRC subordinate slice. For instance, response and communication registers 1516 receive CRC sub-task instructions 1522 from slice coordinator 1512 and encrypted data 1524 from encryption engine 1514. Response and communication registers 1516 transmit a CRC sub-command 1526 including CRC sub-task instructions 1522 and encrypted data 1524 to interface 1508, which transmits CRC sub-command 1526 to CRC subordinate slice 1506.

CRC subordinate slice 1506 is configured to process encrypted data 1524 and append a CRC value to it. As illustrated in FIG. 15, CRC subordinate slice 1506 generates a response 1528 and transmits response 1528 to processor core 1502. Depending on the implementation, response 1528 may include data such as encrypted data 1524 appended with a CRC value, status information, or other information related to performing encrypt and CRC command 1518. In accordance with an embodiment, CRC subordinate slice 1506 may transmit response 1528 to complex communication coordinator slice 1504, which generates a coordinated response to transmit to processor core 1502.

Thus, an example embodiment of a complex computation coordinator slice and a flowchart of a process for performing a complex computation have been described with respect to FIGS. 15 and 16. While the complex computation described above illustrates an encryption and CRC complex computation, it is contemplated herein that other implementations of complex computation coordinator slices may perform other complex computations. For instance, a complex computation may include any one or more of a data move command, a synchronization command, an encryption command, a CRC command, and/or another command to be performed by a distributed accelerator, as described elsewhere herein and/or as would be understood by a person of skill in the relevant art(s) having benefit of this disclosure.

### IV. Further Example Embodiments and Advantages

As noted above, systems and devices, including distributed accelerators, coordinator slices, and subordinate slices, may be configured in ways to perform tasks. Accelerator slices have been described as network-attached devices, off-chip devices, on-chip devices, on-chip processing elements, or as a specialized instruction in an ISA, in embodiments. Various types of coordinator slices have been described herein, however it is contemplated herein that subordinate slices may include specialized hardware for performing particular tasks, as would be understood by persons of skill in the relevant art(s) having the benefit of this disclosure. For instance, a subordinate slice may include hardware specialized for data movement, synchronization, CRC, cryptography, complex computations, and/or the like. Furthermore, embodiments of the present disclosure may be configured to support coherent caches, increased bandwidth, quality of service monitoring, metering (e.g., for billing), depending on the particular implementation.

Embodiments of distributed accelerators may support virtual memory. A distributed accelerator in accordance with an embodiment translates a virtual address received with a command (e.g., a logic block address) to a physical address of a memory device. The physical address may be used for write operations, read operations, or other operations associated with the physical memory (e.g., handling page faults). In an example embodiment, a distributed accelerator stores translated addresses in a cache to minimize translation overheads.

Embodiments of the present disclosure may be configured to accelerate task performance. For instance, in a non-limiting example, a distributed accelerator in accordance with an embodiment is configured to process commands without a local address translation. In this context, the processor core translates a virtual address to a physical address and transmits a command to the distributed accelerator with the physical address. Such implementations may reduce the complexity and/or the size of the accelerator.

Moreover, according to the described embodiments and techniques, any components of processing systems, distributed accelerators, coordinator slices, and/or subordinate slices and their functions may be caused to be activated for operation/performance thereof based on other operations, functions, actions, and/or the like, including initialization, completion, and/or performance of the, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The further example embodiments and advantages described in this Section may be applicable to any embodiments disclosed in this Section or in any other Section of this disclosure.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

### V. Example Computer System Implementations

Processor core 102, distributed accelerator 104, accelerator slices 108, coordinator slice 110, subordinate slices 112A-112N, processor cores 202A-202N, cache controllers 204A-204N, memory controllers 206A-206N, IO controllers 208A-208N, distributed accelerator 210, coordinator slice 212, subordinate slices 214A-214N, subordinate slices 216A-216N, subordinate slices 218A-218N, coherence engines 220A-220N, caches 222A-222N, interconnect 224, coordinator slice 304, subordinate slices 306A-306N, interface 308, slice controller 310, command manager 312, slice coordinator 314, response and communication registers 316, execution engines 318, data buffers 320, status manager 322, abort task manager 324, coordinated response generator 326, completion time estimator 328, command queue 330, sub-task generator 332, slice allocator 334, sub-instruction generator 336, interface 368, slice controller 370, command queue 372, response and communication registers 374, execution engines 376, data buffers 378, flowchart 400 coordinator slice 504, subordinate slices 506A-506N, interface 508, command manager 510, slice coordinator 512, status manager 514, response and communication registers 516, coordinated response generator 518, flowchart 600, coordinator slice 704, subordinate slices 706A-706B, interface 708, command manager 710, abort task manager 712, slice coordinator 714, response and communication registers 716, execution engines 718, status manager 720, abort condition identifier 722, abort task determiner 724, flowchart 800, completion time estimator 900, command analyzer 902, load analyzer 904, estimated completion time determiner 906, threshold analyzer 908, latency log updater 910, command latency log 912, flowchart 1000, processor cores 1102A-1102N, distributed accelerator 1104, interconnect 1106, coordinator slice 1108, data mover coordinator slice 1110, synchronization coordinator slice 1112, crypto coordinator slice 1114, CRC coordinator slice 1116, complex computation coordinator slice 1118, subordinate slices 1120A-1120N, processor core 1202, data mover coordinator slice 1204, data mover subordinate slice 1206, data mover subordinate slice 1208, flowchart 1300, CRC coordinator slice 1400, interface 1402, slice controller 1404, command manager 1406, slice coordinator 1408, response and communication registers 1410, execution engines 1412, processor core 1502, complex computation coordinator slice 1504, CRC subordinate slice 1506, interface 1508, command manager 1510, slice coordinator 1512, encryption engine 1514, response and communication registers 1516, and/or flowchart 1600 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 17 depicts an exemplary implementation of a computer system 1700 (“system 1700” herein) in which embodiments may be implemented. For example, system 1700 may be used to implement processor core 102 and/or distributed accelerator 104, as described above in reference to FIG. 1. System 1700 may also be used to implement processor cores 202A-202N, cache controllers 204A-204N, memory controllers 206A-206N, IO controllers 208A-208N, and/or distributed accelerator 210, as described above in reference to FIG. 2. System 1700 may also be used to implement distributed accelerator 300, as described above in reference to FIG. 3A. System 1700 may also be used to implement subordinate slice 306A, as described above in reference to FIG. 3B. System 1700 may also be used to implement distributed accelerator 500, as described above in reference to FIG. 5. System 1700 may also be used to implement distributed accelerator 700, as described above in reference to FIG. 7. System 1700 may also be used to implement completion time estimator 900, as described above in reference to FIG. 9. System 1700 may also be used to implement processor cores 1102A-1102N and/or distributed accelerator 1104, as described in reference to FIG. 11. System 1700 may also be used to implement processor core 1202, data mover coordinator slice 1204, data mover subordinate slice 1206, and/or data mover subordinate slice 1208, as described above in reference to FIG. 12. System 1700 may also be used to implement CRC coordinator slice 1400, as described above in reference to FIG. 14. System 1700 may also be used to implement processor core 1502, complex computation coordinator slice 1504, and/or CRC subordinate slice 1506, as described above in reference to FIG. 15. System 1700 may also be used to implement any of the steps of any of the flowcharts of FIG. 4, FIG. 6, FIG. 8, FIG. 10, FIG. 13, and/or FIG. 16, as described above. The description of system 1700 provided herein is provided for purposes of illustration and is not intended to be limiting. Embodiments may be implemented in further types of computer systems, as would be known to persons skilled in the relevant art(s).

As shown in FIG. 17, system 1700 includes one or more processors, referred to as processor unit 1702, a system memory 1704, and a bus 1706 that couples various system components including system memory 1704 to processor unit 1702. Processor unit 1702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor unit 1702 may execute program code stored in a computer readable medium, such as program code of operating system 1730, application programs 1732, other programs 1734, etc. Bus 1706 represents one or more of any of several types of bus structures, including a memory bus or memory controller, a peripheral bus, an accelerated graphics port, and a processor or local bus using any of a variety of bus architectures. System memory 1704 includes read only memory (ROM) 1708 and random-access memory (RAM) 1710. A basic input/output system 1712 (BIOS) is stored in ROM 1708.

System 1700 also has one or more of the following drives: a hard disk drive 1714 for reading from and writing to a hard disk, a magnetic disk drive 1716 for reading from or writing to a removable magnetic disk 1718, and an optical disk drive 1720 for reading from or writing to a removable optical disk 1722 such as a CD ROM, DVD ROM, or other optical media. Hard disk drive 1714, magnetic disk drive 1716, and optical disk drive 1720 are connected to bus 1706 by a hard disk drive interface 1724, a magnetic disk drive interface 1726, and an optical drive interface 1728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards and drives (e.g., solid state drives (SSDs)), digital video disks, RAMs, ROMs, and other hardware storage media.

A number of program modules or components may be stored on the hard disk, magnetic disk, optical disk, ROM, or RAM. These program modules include an operating system 1730, one or more application programs 1732, other program modules 1734, and program data 1736. In accordance with various embodiments, the program modules may include computer program logic that is executable by processing unit 1702 to perform any or all the functions and features of coherence engines 220A-220N, slice controller 310, command manager 312, slice coordinator 314, response and communication registers 316, status manager 322, abort task manager 324, coordinated response generator 326, completion time estimator 328, sub-task generator 332, slice allocator 334, sub-instruction generator 336, slice controller 370, command manager 510, slice coordinator 512, status manager 514, coordinated response generator 518, command manager 710, abort task manager 712, slice coordinator 714, response and communication registers 716, execution engines 718, status manager 720, abort condition identifier 722, abort task determiner 724, completion time estimator 900, command analyzer 902, load analyzer 904, estimated completion time determiner 906, threshold analyzer 908, latency log updater 910, command latency log 912, slice controller 1404, command manager 1406, slice coordinator 1408, response and communication registers 1410, execution engines 1412, command manager 1510, slice coordinator 1512, and/or encryption engine 1514 (including any suitable steps of flowcharts 400, 600, 800, 1000, 1300, and/or 1600).

A user may enter commands and information into the system 1700 through input devices such as keyboard 1738 and pointing device 1740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor unit 1702 through a serial port interface 1742 that is coupled to bus 1706, but may be connected by other interfaces, such as a parallel port, game port, or a universal serial bus (USB).

A display screen 1744 is also connected to bus 1706 via an interface, such as a video adapter 1746. Display screen 1744 may be external to, or incorporated in, system 1700. Display screen 1744 may display information, as well as being a user interface for receiving user commands and/or other information (e.g., by touch, finger gestures, virtual keyboard, etc.). In addition to display screen 1744, system 1700 may include other peripheral output devices (not shown) such as speakers and printers.

System 1700 is connected to a network 1748 (e.g., the Internet) through an adaptor or network interface 1750, a modem 1752, or other means for establishing communications over the network. Modem 1752, which may be internal or external, may be connected to bus 1706 via serial port interface 1742, as shown in FIG. 17, or may be connected to bus 1706 using another interface type, including a parallel interface.

As used herein, the terms “computer program medium,” “computer-readable medium,” and “computer-readable storage medium” are used to refer to physical hardware media such as the hard disk associated with hard disk drive 1714, removable magnetic disk 1718, removable optical disk 1722, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1732 and other programs 1734) may be stored on the hard disk, magnetic disk, optical disk, ROM, RAM, or other hardware storage medium. Such computer programs may also be received via network interface 1750, serial port interface 1742, or any other interface type. Such computer programs, when executed or loaded by an application, enable system 1700 to implement features of embodiments described herein. Accordingly, such computer programs represent controllers of the system 1700.

Embodiments are also directed to computer program products comprising computer code or instructions stored on any computer-readable medium. Such computer program products include hard disk drives, optical disk drives, memory device packages, portable memory sticks, memory cards, and other types of physical storage hardware. In accordance with various embodiments, the program modules may include computer program logic that is executable by processing unit 1702 to perform any or all of the functions and features of processor core 102 and/or distributed accelerator 104, as described above in reference to FIG. 1, processor cores 202A-202N, cache controllers 204A-204N, memory controllers 206A-206N, IO controllers 208A-208N, and/or distributed accelerator 210, as described above in reference to FIG. 2, distributed accelerator 300, as described above in reference to FIG. 3A, subordinate slice 306A, as described above in reference to FIG. 3B, distributed accelerator 500, as described above in reference to FIG. 5, distributed accelerator 700, as described above in reference to FIG. 7, completion time estimator 900, as described above in reference to FIG. 9, processor cores 1102A-1102N and/or distributed accelerator 1104, as described in reference to FIG. 11, processor core 1202, data mover coordinator slice 1204, data mover subordinate slice 1206, and/or data mover subordinate slice 1208, as described above in reference to FIG. 12, CRC coordinator slice 1400, as described above in reference to FIG. 14, processor core 1502, complex computation coordinator slice 1504, and/or CRC subordinate slice 1506, as described above in reference to FIG. 15. The program modules may also include program logic that, when executed by processing unit 1302, causes processing unit 1302 to perform any of the steps of any of the flowcharts of FIG. 4, FIG. 6, FIG. 8, FIG. 10, FIG. 13, and/or FIG. 16, as described above.

### VI. Additional Exemplary Embodiments

In an embodiment, a processing system includes a distributed accelerator including a plurality of accelerator slices. The plurality of accelerator slices includes one or more subordinate slices and a coordinator slice. The coordinator slice is configured to receive a command that includes instructions for performing a task. The coordinator slice is configured to determine one or more sub-tasks of the task to generate a set of sub-tasks. For each sub-task of the set of sub-tasks, the coordinator slice is configured to allocate an accelerator slice of the plurality of accelerator slices to perform the sub-task, determine sub-task instructions for performing the sub-task, and transmit the sub-task instructions to the allocated accelerator slice. Each allocated accelerator slice is configured to generate a corresponding response indicative of the allocated accelerator slice having completed a respective sub-task.

In an embodiment, the coordinator slice is further configured to receive, from each allocated accelerator slice, the corresponding response indicative of the allocated accelerator slice having completed a respective sub-task. The coordinator slice is configured to generate a coordinated response indicative of the corresponding responses.

In an embodiment, the command is received from a processor core. Each allocated accelerator slice transmits the corresponding response indicative of the allocated accelerator slice having completed the respective sub-task to the processor core.

In an embodiment, the plurality of accelerator slices includes a plurality of coordinator slices.

In an embodiment, the processing system includes an interconnect network configured to transfer signals between the coordinator slice and the one or more subordinate slices. At least one accelerator slice of the plurality of accelerator slices is directly coupled to the interconnect network.

In an embodiment, the coordinator slice is one of: a data mover coordinator slice, a synchronization coordinator slice, a crypto coordinator slice, a cyclic redundancy check (CRC) coordinator slice, or a complex computation coordinator slice.

In an embodiment, the processing system includes a cache controller. The cache controller includes the coordinator slice. The task includes instructions to move data from a first location to a second location. The coordinator slice is a data mover coordinator slice configured to determine the one or more sub-tasks of the task by determining a set of portions of the data and determining, for each portion of the set of portions of the data, a sub-task for moving the portion.

In an embodiment, the coordinator slice is a complex computation coordinator slice configured to receive an encrypt and cyclic redundancy check (CRC) command including data. The complex computation coordinator slice is configured to determine an encrypt sub-task and a CRC sub-task, allocate the coordinator slice to perform the encrypt sub-task and a CRC subordinate slice of the one or more subordinate slices to perform the CRC sub-task, and determine encrypt sub-task instructions and CRC sub-task instructions. The complex computation coordinator slice is configured to perform the encrypt sub-task instructions by encrypting the included data and transmit the CRC sub-task instructions and the encrypted data to the CRC subordinate slice.

In an embodiment, the coordinator slice is further configured to receive a status update command that includes a request for progression of the task, transmit a status update instruction to the allocated accelerator slices, and receive, from each allocated accelerator slice, a corresponding status update response. The corresponding status update response is indicative of the progression of the allocated accelerator slice performing the respective sub-task. The coordinator slice is configured to generate a coordinated status update indicative of one or more received status update responses.

In an embodiment, the coordinator slice includes a data buffer, and the received command designates a physical address of the data buffer.

In an embodiment, the coordinator slice is further configured to determine, based on a command load of the distributed accelerator, an estimated completion time of the command. If the estimated completion time is below a wait threshold, the coordinator slice is configured to position the received command in a command queue. If the estimated completion time is above the wait threshold the coordinator slice is configured to generate a rejection response.

In an embodiment, the coordinator slice is further configured to identify an abort condition, determine one or more sub-tasks of the set of sub-tasks to be aborted, and transmit an abort instruction to each allocated accelerator slice associated with the determined one or more sub-tasks to be aborted.

In an embodiment, a method for performing a task by a distributed accelerator is performed. The method includes receiving a command that includes instructions for performing a task. One or more sub-tasks of the task are determined to generate a set of sub-tasks. For each sub-task of the set of sub-tasks, an accelerator slice of a plurality of accelerator slices of the distributed accelerator is allocated to perform the sub-task. For each sub-task of the set of sub-tasks, sub-task instructions are determined for performing the sub-task. For each sub-task of the set of sub-tasks, the sub-task instructions are transmitted to the allocated accelerator slice. A corresponding response is received from each allocated accelerator slice. Each corresponding response is indicative of the allocated accelerator slice having completed a respective sub-task. A coordinated response indicative of the corresponding responses is generated.

In an embodiment, the task includes instructions to move data from a first location to a second location. The determining the one or more sub-tasks of the task includes: determining a set of portions of the data and determining, for each portion of the set of portions of the data, a sub-task for moving the portion.

In an embodiment, a status update command that includes a request for progression of the task is received. A status update instruction is transmitted to the allocated accelerator slices. A corresponding status update response is received from each allocated accelerator slice. Each corresponding status update response is indicative of the progression of the allocated accelerator slice performing the respective sub-task. A coordinated status update indicative of the one or more received status update responses is generated.

In an embodiment, an estimated completion time of the command is determined based on a command load of the distributed accelerator. If the estimated completion time is below a wait threshold, the received command is positioned in a command queue. If the estimated completion time is above the wait threshold, a rejection response is generated.

In an embodiment, an abort condition is identified. One or more sub-tasks of the set of sub-tasks are determined to be aborted. An abort instruction is transmitted to each allocated accelerator slice associated with the determined one or more sub-tasks to be aborted.

In an embodiment, a coordinator slice is configured to allocate accelerator slices of a plurality of accelerator slices of a distributed accelerator to perform a task. The plurality of accelerator slices includes the coordinator slice. The coordinator slice is further configured to receive a command that includes instructions for performing the task and determine one or more sub-tasks of the task to generate a set of sub-tasks. For each sub-task of the set of sub-tasks, the coordinator slice is configured to allocate an accelerator slice of the plurality of accelerator slices of the distributed accelerator to perform the sub-task, determine sub-task instructions for performing the sub-task, and transmit the sub-task instructions to the allocated accelerator slice. The coordinator slice is configured to receive, from each allocated accelerator slice, a corresponding response indicative of the allocated accelerator slice having completed a respective sub-task. The coordinator slice is configured to generate a coordinated response indicative of the corresponding responses.

In an embodiment, the task includes instructions to move data from a first location to a second location. The coordinator slice is configured to determine the one or more sub-tasks of the task to generate the set of sub-tasks by determining a set of portions of the data and determining, for each portion of the set of portions of the data, a sub-task for moving the portion.

In an embodiment, the coordinator slice is further configured to receive a status update command that includes a request for progression of the task and transmit a status update instruction to the allocated accelerator slices. The coordinator slice is further configured to receive, from each allocated accelerator slice, a corresponding status update response indicative of the progression of the allocated accelerator slice performing the respective sub-task and generate a coordinated status update indicative of the one or more received status update responses.

### VII. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A processing system comprising:
a distributed accelerator including a plurality of accelerator slices, the plurality of accelerator slices including:
one or more subordinate slices; and
a coordinator slice configured to:
receive a command that includes instructions for performing a task;
determine one or more sub-tasks of the task to generate a set of sub-tasks;
for each sub-task of the set of sub-tasks:
allocate an accelerator slice of the plurality of accelerator slices to perform the sub-task;
determine sub-task instructions for performing the sub-task; and
transmit the sub-task instructions to the allocated accelerator slice;
wherein, each allocated accelerator slice is configured to generate a corresponding response indicative of the allocated accelerator slice having completed a respective sub-task.

2. The processing system of claim 1, wherein the coordinator slice is further configured to:
receive, from each allocated accelerator slice, the corresponding response indicative of the allocated accelerator slice having completed a respective sub-task; and
generate a coordinated response indicative of the corresponding responses.

3. The processing system of claim 1, wherein the command is received from a processor core, and wherein each allocated accelerator slice transmits the corresponding response indicative of the allocated accelerator slice having completed the respective sub-task to the processor core.

4. The processing system of claim 1, wherein the plurality of accelerator slices includes a plurality of coordinator slices.

5. The processing system of claim 1, further comprising:
an interconnect network configured to transfer signals between the coordinator slice and the one or more subordinate slices, wherein at least one accelerator slice of the plurality of accelerator slices is directly coupled to the interconnect network.

6. The processing system of claim 1, wherein the coordinator slice is one of:
a data mover coordinator slice;
a synchronization coordinator slice;
a crypto coordinator slice;
a cyclic redundancy check (CRC) coordinator slice; or
a complex computation coordinator slice.

7. The processing system of claim 1, the processing system further comprising a cache controller, the cache controller including the coordinator slice, wherein:
the task includes instructions to move data from a first location to a second location; and
the coordinator slice is a data mover coordinator slice configured to determine the one or more sub-tasks of the task by:
determining a set of portions of the data; and
determining, for each portion of the set of portions of the data, a sub-task for moving the portion.

8. The processing system of claim 1, wherein the coordinator slice is a complex computation coordinator slice configured to:
receive an encrypt and cyclic redundancy check (CRC) command including data;
determine an encrypt sub-task and a CRC sub-task;
allocate the coordinator slice to perform the encrypt sub-task and a CRC subordinate slice of the one or more subordinate slices to perform the CRC sub-task;
determine encrypt sub-task instructions and CRC sub-task instructions;
perform the encrypt sub-task instructions by encrypting the included data; and
transmit the CRC sub-task instructions and the encrypted data to the CRC subordinate slice.

9. The processing system of claim 1, wherein the coordinator slice is further configured to:
receive a status update command that includes a request for progression of the task;
transmit a status update instruction to the allocated accelerator slices;
receive, from each allocated accelerator slice, a corresponding status update response indicative of the progression of the allocated accelerator slice performing the respective sub-task; and
generate a coordinated status update indicative of one or more received status update responses.

10. The processing system of claim 1, wherein the coordinator slice includes a data buffer and the received command designates a physical address of the data buffer.

11. The processing system of claim 1, wherein the coordinator slice is further configured to:
determine, based on a command load of the distributed accelerator, an estimated completion time of the command;
if the estimated completion time is below a wait threshold, position the received command in a command queue; and
if the estimated completion time is above the wait threshold; generate a rejection response.

12. The processing system of claim 1, wherein the coordinator slice is further configured to:
identify an abort condition;
determine one or more sub-tasks of the set of sub-tasks to be aborted; and
transmit an abort instruction to each allocated accelerator slice associated with the determined one or more sub-tasks to be aborted.

13. A method for performing a task by a distributed accelerator, the method comprising:
receiving a command that includes instructions for performing a task;
determining one or more sub-tasks of the task to generate a set of sub-tasks;
for each sub-task of the set of sub-tasks:
allocating an accelerator slice of a plurality of accelerator slices of the distributed accelerator to perform the sub-task;
determining sub-task instructions for performing the sub-task; and
transmitting the sub-task instructions to the allocated accelerator slice;
receiving, from each allocated accelerator slice, a corresponding response indicative of the allocated accelerator slice having completed a respective sub-task; and
generating a coordinated response indicative of the corresponding responses.

14. The method of claim 13, wherein the task includes instructions to move data from a first location to a second location, and said determining the one or more sub-tasks of the task includes:
determining a set of portions of the data; and
determining, for each portion of the set of portions of the data, a sub-task for moving the portion.

15. The method of claim 13, further comprising:
receiving a status update command that includes a request for progression of the task;
transmitting a status update instruction to the allocated accelerator slices;
receiving, from each allocated accelerator slice, a corresponding status update response indicative of the progression of the allocated accelerator slice performing the respective sub-task; and
generating a coordinated status update indicative of the one or more received status update responses.

16. The method of claim 13, further comprising:
determining, based on a command load of the distributed accelerator, an estimated completion time of the command;
if the estimated completion time is below a wait threshold, positioning the received command in a command queue; and
if the estimated completion time is above the wait threshold; generating a rejection response.

17. The method of claim 13, further comprising:
identifying an abort condition;
determining one or more sub-tasks of the set of sub-tasks to be aborted; and
transmitting an abort instruction to each allocated accelerator slice associated with the determined one or more sub-tasks to be aborted.

18. A coordinator slice configured to allocate accelerator slices of a plurality of accelerator slices of a distributed accelerator to perform a task, the plurality of accelerator slices including the coordinator slice, the coordinator slice further configured to:
receive a command that includes instructions for performing the task;
determine one or more sub-tasks of the task to generate a set of sub-tasks;
for each sub-task of the set of sub-tasks:
allocate an accelerator slice of the plurality of accelerator slices of the distributed accelerator to perform the sub-task;
determine sub-task instructions for performing the sub-task; and
transmit the sub-task instructions to the allocated accelerator slice;
receive, from each allocated accelerator slice, a corresponding response indicative of the allocated accelerator slice having completed a respective sub-task; and
generate a coordinated response indicative of the corresponding responses.

19. The coordinator slice of claim 18, wherein the task includes instructions to move data from a first location to a second location, and the coordinator slice is configured to determine the one or more sub-tasks of the task to generate the set of sub-tasks by:
determining a set of portions of the data; and
determining, for each portion of the set of portions of the data, a sub-task for moving the portion.

20. The coordinator slice of claim 18, wherein said coordinator slice is further configured to:
receive a status update command that includes a request for progression of the task;
transmit a status update instruction to the allocated accelerator slices;
receiving, from each allocated accelerator slice, a corresponding status update response indicative of the progression of the allocated accelerator slice performing the respective sub-task; and
generate a coordinated status update indicative of the one or more received status update responses.
